(19) United States
(12) Patent Application Publication
(10) Pub. No.: US 2004/0101619 A1
(43) Pub. Date: May 27, 2004

(54) Object decoration

(76) Inventor: Carlo Camorani, Roteglia Di Castellarano (IT)

Correspondence Address: WILLIAM COLLARD, COLLARD & ROE, P.C., 1077 NORTHERN BOULEVARD, ROSLYN, NY, 11576, US

(21) Appl. No.: 10/275,036

(22) PCT Filed: Mar. 28, 2001
(86) PCT No.: PCT/IB01/00505

(30) Foreign Application Priority Data
Mar. 30, 2000 (IT) MO2000A000063
Mar. 30, 2000 (IT) M02000A000064
Apr. 21, 2000 (IT) M02000A000080
Apr. 21, 2000 (IT) M02000A000081
Apr. 21, 2000 (IT) M020000A000082
May 5, 2000 (IT) MO2000A000092
May 31, 2000 (IT) MO2000A000117
Nov. 29, 2000 (IT) M02000A000259

(51) Int. Cl. B05D 1/12

(52) U.S. Cl. 427/180; 427/475; 118/326; 118/308

(57) ABSTRACT

A method and a device for applying powdered material on a surface comprise forming a flow of liquid, preferably by ejecting said liquid as drops from ejectors arranged in array and controlled by computer means, associating portions of said powdered material with said flow of liquid, moving said flow of liquid, together with said portions, towards said surface.

The invention relates to methods and devices for applying powdered or granulated material on a surface, in particular for carrying out decorations on ceramic tiles, according to a pattern directly controlled by a computer, possibly with decorating material arranged on a consistent thickness.

The invention relates also to methods and relative apparatus for decorating in a pressing step ceramic tiles made of powdered or granulated material.

Ink-jet printing systems are known constituted by aligned groups of small ejecting nozzles which project small ink drops on the surface to be printed. Various embodiments of such ink-jet heads are known, based on different principles such as: electromechanical, with piezoelectric vibration, thermal systems where the ink is injected through the expansion due to bubbles formation, and more again.

The use of such systems is greatly limited since they can work only with inks in a liquid state or in a state of very thin and fluid suspension, as the use of solid materials in suspension produces significant problems of wear, settling and occlusion.

In Italian Patent 1.294.915 an apparatus is disclosed for distributing measured amounts of materials in granular and/or powdery form. Said apparatus comprises a hopper at the bottom of which a plurality of openings are aligned, said openings being normally closed each by a relative elastic foil. Each foil is singularly controlled electromagnetically by a computer which enables the openings to be opened and causes the powder contained in the hopper to flow by gravity.

With such system, however, it is not possible to obtain a good image definition since the openings can not be excessively small, otherwise the powder flow is prevented; furthermore only highly loose powders may be used, having a size complying with the opening size. In addition, the definition is quite deteriorated, since the powder is slowly and uncertainly moved as an effect of the single force of gravity and also since the powders tend to spread and to move on the surface to be decorated, when impacting said surface.

A technology is known which provides laying various overlapping layers of decorating powdered materials on a base layer designed for forming the support layer and pressing the whole inside a die cavity or directly over a belt. The tiles produced with such technology have the drawback that, due to wear caused by walking (or by surface polishing which is often performed for making the surface shiny), the surface layers are removed, which causes an unacceptable change in the decoration appearance.

For solving this problem, in the patent application for industrial invention RE96A000004 mutually remixing said decorating layers is provided, said remixing occurring during the falling path inside the die cavity by means of suitable deflector walls. Even though the previously explained problem is solved, this system is not suitable for carrying out decorations having definite contours but only highly faded decorations (venations), since during the remixing action the decorating powders are also subjected to significant displacements and remixing in lateral direction.

For solving the same explained problem, in the patents U.S. Pat. No. 5,368,791, U.S. Pat. No. 5,54,393, U.S. Pat. No. 5,736,084 and EP 0974437 it is provided using (in different manners) devices provided with a plurality of separate cells inside which the decorating powders are temporarily arranged.

Such method allows: the decorating materials to be kept separated inside a single cell, their lateral displacement to be avoided, a remixing to be possibly obtained without interfering with powders of the adjacent cells.

However, also in this case, in addition to an obvious mechanical complication, a high pattern resolution is not possible as said cells cannot have very small size, since the powders have to enter into said cells and exit therefrom without difficulties and mainly since said powders need to move freely inside the cells for being remixed. On the other hand, such system does not allow progressive shadings to be obtained, since progressive shadings require an unlimited number of cells and furthermore the walls of said cells, even if they are very thin, may constitute disturbing regions on the layer of deposited decoration, being visible on the finished product.

For succeeding in deeply decorating the surface of ceramic tiles, using dyes in a liquid solution state is known: since the surface is porous, the dye may penetrate inside said surface by capillarity; such technique has the drawback that said liquid solution deeply penetrates but at least equally expands also laterally, thus producing poorly defined drawing contours.

In the Italian Patent 1.262.691 it is provided using a belt matrix provided with small cavities which are filled with decorating material, said decorating material being subsequently projected on the surface to be decorated. This system does not allow, however, the drawing shape to be modified, unless changing said matrix.

In the Italian Patent 1.162.831 decorating porcelain plates is provided, by using a die consisting of a lower punch and an upper punch, a layer of decorating material being applied on the upper half-die, by damp pad printing, before closing the die, said decorating material being transferred to the plate surface during pressing.

It is provided that said upper half-die is constituted by various radially equally spaced units arranged about a vertical axis of rotation. Said half-dies are rotatingly indexed about the rotation axis, so as to successively reach the pressing station and the transferring station, for respectively pressing and transferring the decorating materials. If the technique of damp decorating is used on a smooth surface like the half-die, a significant image definition may be advantageously obtained, said definition being comparable with the definition obtained on an already pressed product, with the further advantage that the decorating material is more integrated in the body and further operations on the pressed body may be avoided.

However, such system may be hardly applied for the production of ceramic tiles since, being the tile size actually required by the market greater and greater, huge spaces and remarkable complications would be necessary for preparing such type of press.

This problem is even more serious if it is considered that tile dies are usually provided with multiple parallel cavities. A further complication is that the decorating material has to be transferred from bottom to top, which prevents direct silk-screen techniques from being used. Furthermore, in such solution, a continuously rotating decoration system cannot be applied.

Furthermore, in the ceramic tile industry almost always presses of a vertical axis type having fixed dies provided with a plurality of cavities are usually employed, with pressing forces often reaching 5000 tons. It is therefore useful exploiting to the utmost such expensive, already existent systems.

In various industrial sectors it is required to decorate or print with powdered material and with computer control of the image. One of the sectors where such requirement is particularly strong is the ceramic tile industry.

A first object of the invention is to solve the prior art problems, i.e. to be able to lay on a surface decorating material in form of powder or also thick suspension, according to a good definition drawing directly controlled by computer, without problems of occlusion and/or wear, without using pre-built printing matrices and therefore with the possibility of real time modifying the decoration pattern, without contacting the surface to be decorated and with a good fixing of the decorating materials on said surface, various powder applications being subsequently arranged on said surface even in reduced times and spaces.

A second object of the invention is to allow powders to be arranged according to a drawing having good definition and resolution, and with a relatively high thickness, and, in advantageous embodiments, with the possibility of mutually mixing layers of various powders and of real time controlling said drawing by computer means.

A third object of the invention is to improve the known systems for decorating tiles during pressing, i.e. to be able to produce ceramic tiles starting from powdered material, said tiles having high definition decorations directly obtained during pressing, with a simple system, high-productivity and even for largest tile sizes and with the possibility of using also the pressing systems already widely used.

A fourth object of the invention is to improve the known systems for decorating tiles during pressing, i.e. to be able to produce ceramic tiles starting from powdered material, said tiles having high definition decorations on the upper face directly obtained during pressing, with simple systems, high productivity and even for the largest tile sizes, with the possibility of also using silk-screen decorating machines with direct printing.

Some of these objects are attained in a first aspect of the invention through a method for applying powdered material on a surface, characterised in that, it is provided:

forming a flow of liquid;

associating portions of said powdered material with said flow of liquid;

moving said flow of liquid, together with said portions, towards said surface.

In a second aspect of the invention a device is provided for applying powdered material on a surface, characterised in that, it comprises ejecting means for ejecting liquid and conveying means suitable for associating portions of said powders to said ejected liquid.

A third aspect of the invention comprises a method for three-dimensionally arranging decorating materials in a body having a decorated surface, characterised in that, it provides the following steps:

forming a continuous or discontinuous stratification, with said decorating materials according to a pattern extending in the plane of said stratification;

transferring said stratification to said body in such a way as to reduce the dimensions of said pattern along a direction parallel to said decorated surface.

In a fourth aspect of the invention a device is provided for three-dimensionally arranging decorating materials in a body, according to a pre-established pattern, characterised in that, it comprises:

a transferring surface suitable for receiving a continuous or discontinuous stratification of said decorating materials;

first means suitable for arranging said decorating materials on said transferring surface, according to a pattern corresponding to said pre-established pattern stretched and enlarged in a direction parallel to said transferring surface;

second means suitable for transferring said decorating materials from said transferring surface to said body so that said decorating materials are arranged according to said pre-established pattern on said body.

A fifth aspect of the invention comprises a method for applying powdered material on a surface according to a pre-established pattern, characterised in that, the following steps are provided:

generating a flow of said powder;

selectively deflecting said flow, so as to cause said flow to be applied on said surface or not to be applied on said surface.

In an advantageous version of this method said deflecting is directly controlled by computer means.

In a sixth aspect of the invention a device is provided suitable for applying powdered material on a surface according to a pre-established pattern, characterised in that, it comprises:

feeding means suitable for forming a flow of said powder;

deflecting means suitable for selectively deflecting said flow and causing said flow to be applied on said surface or not to be applied on said surface.

In an advantageous version of the device, said deflecting means is directly controlled by computer means.

A seventh aspect of the invention comprises a method for decorating tiles, particularly ceramic tiles, characterised in that, the following steps are provided:

applying through applying means a first material on selected regions of the surface of the tile, the extension of said selected regions being controlled by computer means;

distributing on said surface a second material suitable for decoration so as said second material being distributed so as to adhere to said selected regions only or to regions complementary to said selected regions only.

In an eighth aspect of the invention a device is provided for decorating tiles, in particular ceramic tiles, characterised in that, it comprises:

first means suitable for applying a first material to selected regions of the surface of the tile;

computer means controlling the extension of said selected regions;

second means suitable for distributing on said surface a decorating material so as said decorating material adheres only to said selected regions, or only to regions complementary to said selected regions.

A ninth aspect of the invention comprises a method for applying loose material on a surface, characterised in that, the following steps are provided:

arranging a transferring means in a treatment station and associating a first material to selected regions of said transferring means, the extension of said selected regions being controlled by computer means;

applying said loose material to said transferring means;

moving said transferring means close to said surface so as to transfer to said surface said loose material only on regions corresponding to said selected regions, or only on regions corresponding to complementary regions of said selected regions;

moving said transferring means back to said treatment station for cycle repeating.

In a tenth aspect of the invention a device is provided for applying loose material on a surface, characterised in that, it comprises:

a transferring means, movable from a treatment station to an applying station and vice versa;

further means suitable for associating a first material with selected regions of said transferring means, in said treatment station;

computer means controlling the extension of said selected regions;

further second means suitable for applying said loose material to said transferring means;

an applying station wherein said loose material passes from said transferring means to said surface, said passage occurring only in regions corresponding to said selected regions, or only in regions corresponding to the complementary regions of said selected regions.

In an eleventh aspect of the invention a method is provided for applying material, in the form of powders and/or grains, on a surface, characterised in that, it comprises the following steps:

associating said material with a plurality of elements arranged in array;

actively and selectively operating with said elements so as to transfer said material to said surface.

In a twelfth aspect of the invention a method is provided for applying material on a surface, characterised in that, it comprises the following steps:

associating said material with a transferring means;

moving said material on said transferring means towards said surface;

selectively and actively operating with a plurality of elements so as to transfer said material from said transferring means to said surface.

In a thirteenth aspect of the present invention a device is provided for applying a material, in form of powders and/or grains, to a surface, characterised in that, it comprises:

a plurality of elements arranged in array, said material being associated with said plurality of elements;

computer means suitable for selectively actuating said elements for actively transferring said material from said elements to said surface.

In a fourteenth aspect of the present invention a device is provided for applying material on a surface, characterised in that, it comprises:

a transferring means which said material to be applied is associated with;

a plurality of elements suitable for selectively operating on said material so as to transfer said material from said transferring means to said surface, said elements being controlled by computer means point by point.

In a fifteenth aspect of the invention an apparatus for producing ceramic tiles is provided, said ceramic tiles being obtained by pressing powders in a die comprising two half-dies, said half-dies being moved one away from the other during the powders feeding step and being moved one close to the other during said pressing, said tiles being decorated during the pressing step with decorating materials arranged by decorating means on the surface of at least one of said half-dies, characterised in that said half-dies are always vertically aligned and said decorating means is movable from an external position not interfering with said two half-dies to an internal position placed between said two half-dies.

In a sixteenth aspect of the present invention a method is provided for pressing and simultaneously decorating ceramic tiles in a die comprising two half-dies suitable for being moved one closed to the other, comprising the step of pre-arranging decorating materials on at least one of the surfaces of said half-dies by using decorating means, characterised in that, it is provided introducing said decorating means into the space between said two half-dies and it is provided extracting said decorating means before said two half-dies are moved one towards the other.

In a seventeenth aspect of the invention an apparatus is provided for producing objects, particularly ceramic tiles, said objects being obtained by pressing powders and being provided with a surface decorated during pressing comprising:

pressing means arranged above said powders and at least partially rotating around at least a horizontal axis;

decorating means suitable for arranging decorating materials on the surface of said pressing means.

In an eighteenth aspect of the invention a method is provided for producing objects, in particular ceramic tiles, said objects being obtained by pressing powders and being provided with a surface decorated during pressing, comprising the following steps:

arranging decorating materials on the surface of a body rotatingly movable in at least one of its portions about at least one horizontal axis;

moving said surface together with said decorating materials around said at least one horizontal axis so as to overlap said decorating materials to a layer of powders designed for forming the object;

using the surface of said body for pressing the underlying said layer, together with said decorating materials.

In a nineteenth aspect of the invention a method is provided for producing objects, in particular ceramic tiles, said objects being obtained by pressing powders and being provided with a surface decorated during pressing, comprising the following steps:

arranging decorating materials on the surface of a belt;

moving said belt, together with said decorating materials, so as to overlap said decorating materials from above to a layer of powders designed for forming the object;

using said belt for pressing the underlying powders, together with said decorating materials.

In a twentieth aspect of the invention a method is provided for producing objects, in particular ceramic tiles, said objects being obtained by pressing powders and being provided with a surface decorated during pressing, Comprising the following steps:

arranging decorating materials on the external surface of a roller rotatable about a horizontal axis;

rotating said roller, together with said decorating materials, so as to overlap said decorating materials to a layer of powders designed for forming the object;

using the external surface of said roller for pressing the underlying powders together with said decorating materials.

In a twenty-first aspect of the invention a decorating method is provided characterised in that it provides:

forming a flow of decorating powders in an advancing direction;

acting on said flow for modifying said direction.

In a twenty-second aspect of the invention a decorating device is provided characterised in that, it comprises:

forming means for forming a powdered flow along a direction;

modifying means for modifying said direction.

The invention will be better understood from the description of some embodiments forms, shown for exemplifying and not restrictive purpose in the enclosed drawing tables, wherein:

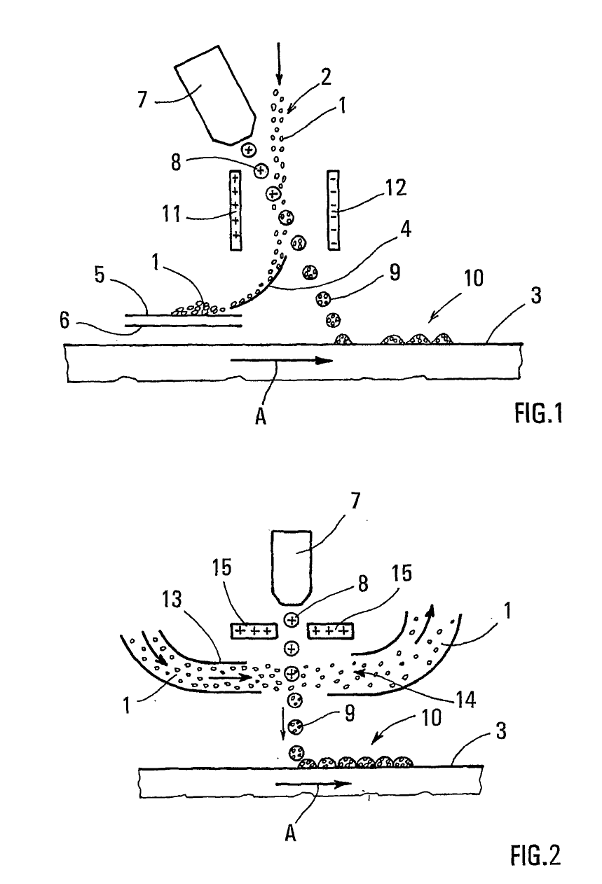

FIG. 1 is a lateral sketched view of the device according to the first and second aspect of the invention, in a first version.

FIG. 2 is a lateral sketched view of the device according to the first and second aspect of the invention, in a different version showing a different system for conveying the powders towards the liquid drops.

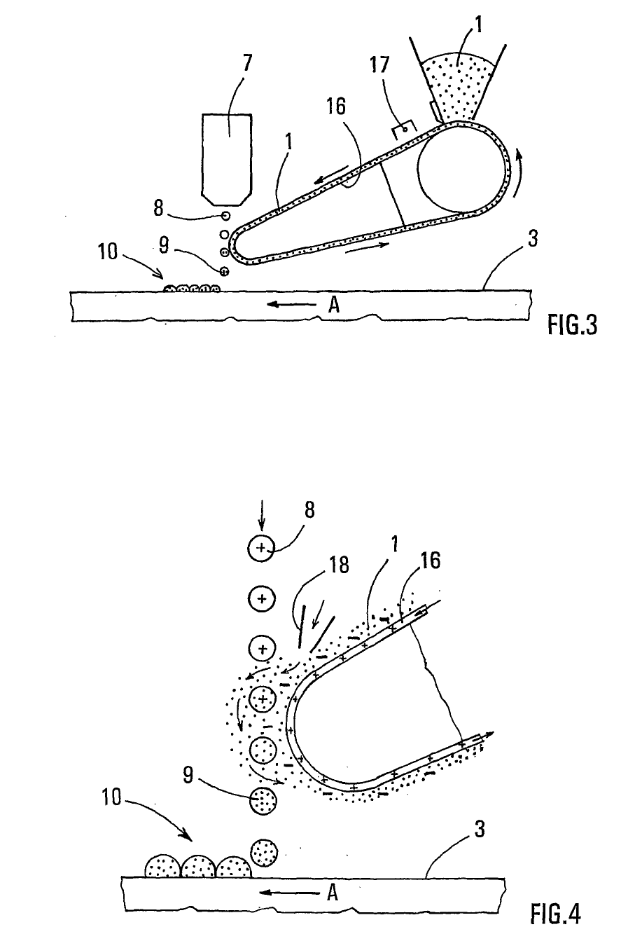

FIG. 3 is a lateral sketched view of the device according to the first and second aspect of the invention, in a third different version showing a further system in order for conveying the powders towards the liquid drops.

FIG. 4 is a lateral, sketched and enlarged view of a detail of the device of FIG. 3.

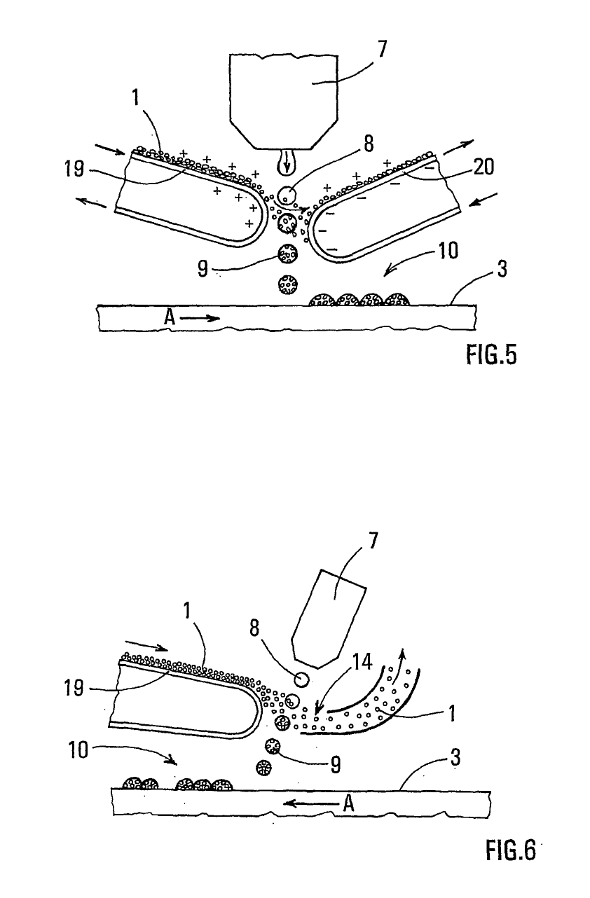

FIG. 5 is a lateral sketched view of the device according to the first and second aspect of the invention, in a fourth different version showing a further system for conveying the powders towards the liquid drops.

FIG. 6 is a lateral sketched view of the device according to the first and second aspect of the invention, in a fifth different version showing a further system for conveying the powders towards the liquid drops.

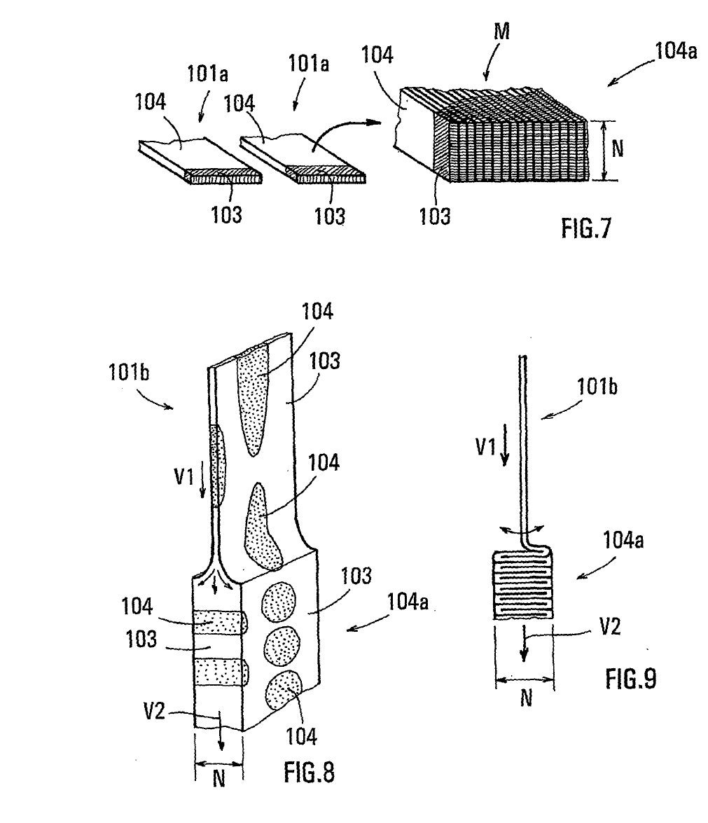

FIG. 7 is a perspective view showing the method according to the third aspect of the invention in a stepwise working version.

FIG. 8 is a perspective view showing the method according to the third aspect of the invention in a continuously working version.

FIG. 9 is a lateral sketched view showing the method according to the third aspect of the invention in a further continuously working version.

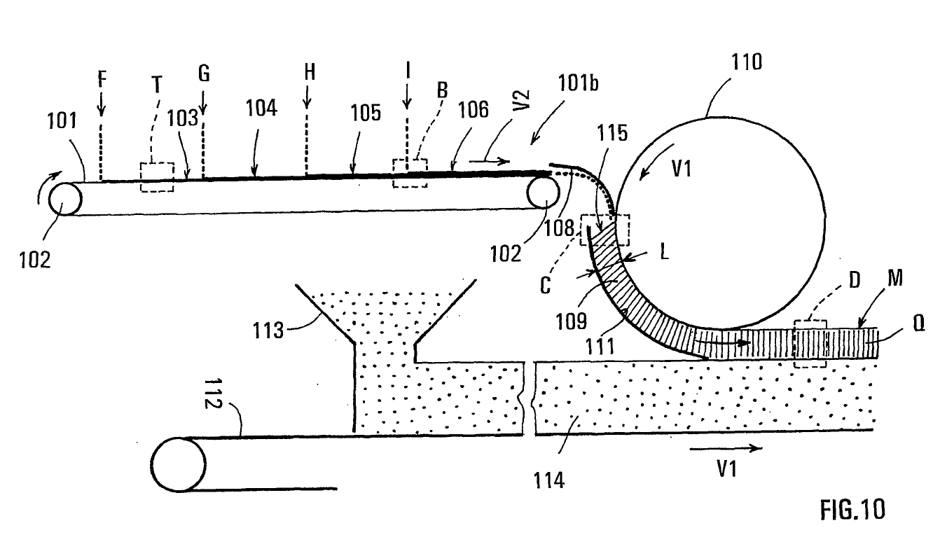

FIG. 10 is a lateral sketched view of the device according to the fourth aspect of the invention in a first version.

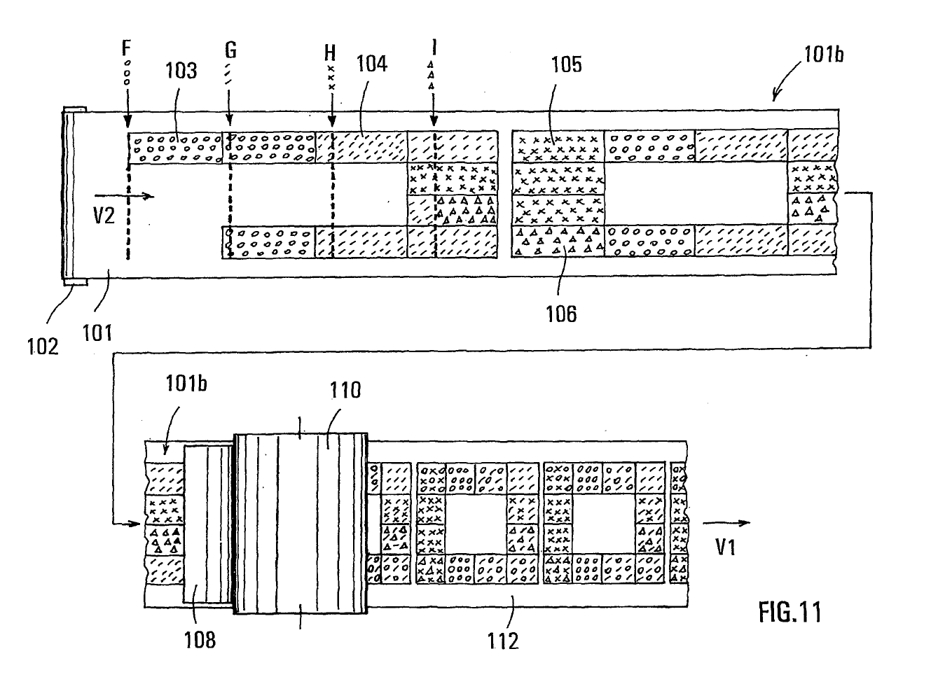

FIG. 11 is a plan view of the device of FIG. 10.

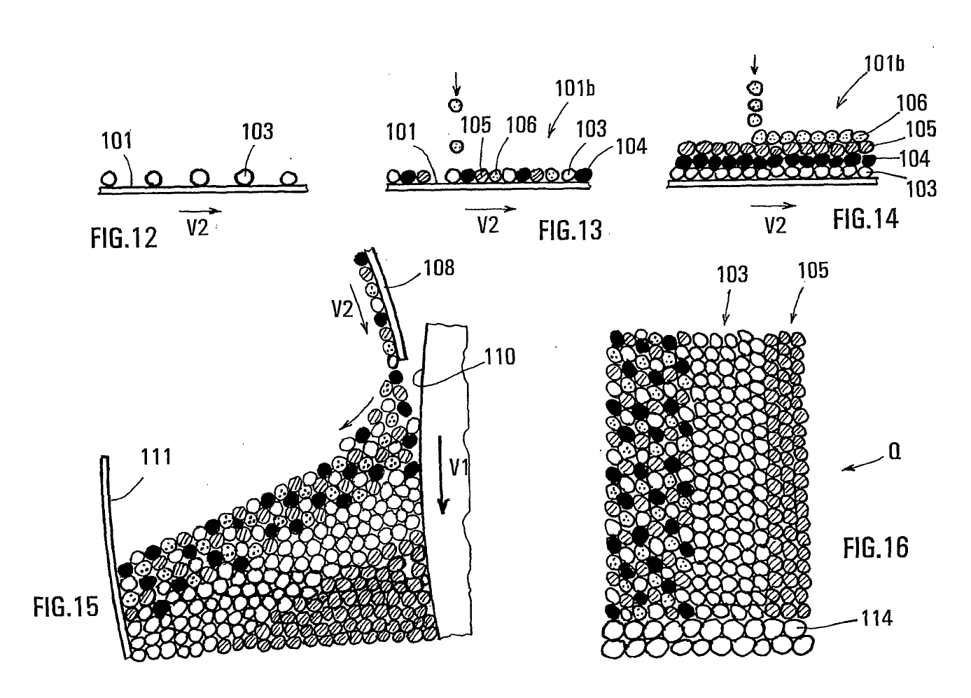

FIG. 12 is a strongly enlarged view of the detail in box T of FIG. 10.

FIG. 13 is a strongly enlarged view of the detail in box B of FIG. 10.

FIG. 14 is a strongly enlarged view of the detail in box B of FIG. 10 in a different working method.

FIG. 15 is a strongly enlarged view of the detail in box C of FIG. 10.

FIG. 16 is a strongly enlarged view of the detail in box D of FIG. 10.

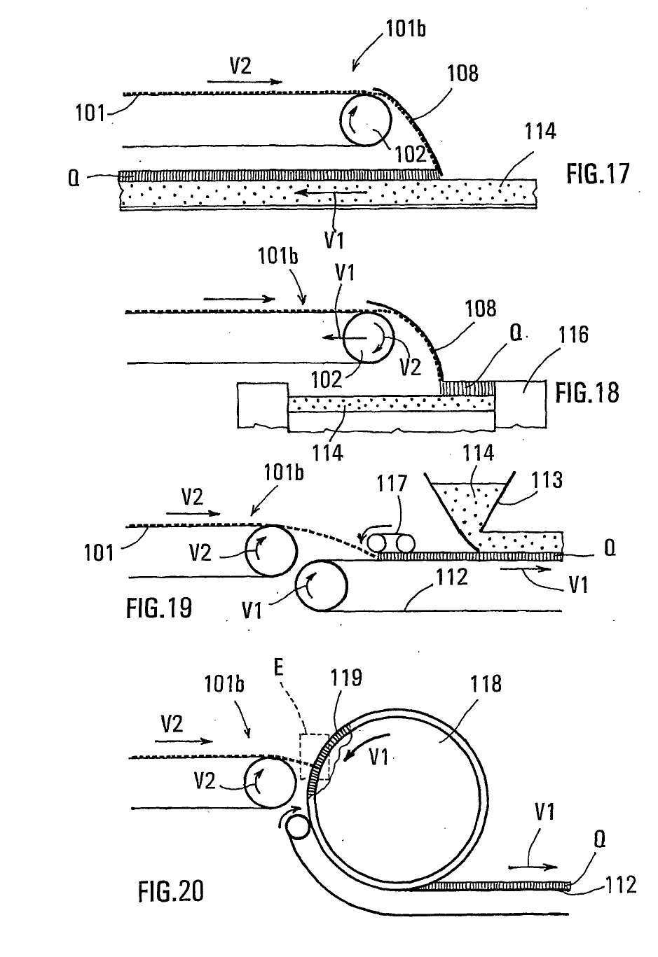

FIG. 17 is a sketched and partial view of the device according to the fourth aspect of the invention in a second version.

FIG. 18 is a sketched and partial view of the device according to the fourth aspect of the invention in a third version.

FIG. 19 is a sketched and partial view of the device according to the fourth aspect of the invention in a fourth version.

FIG. 20 is a sketched and partial view of the device according to the fourth aspect of the invention in a fifth version.

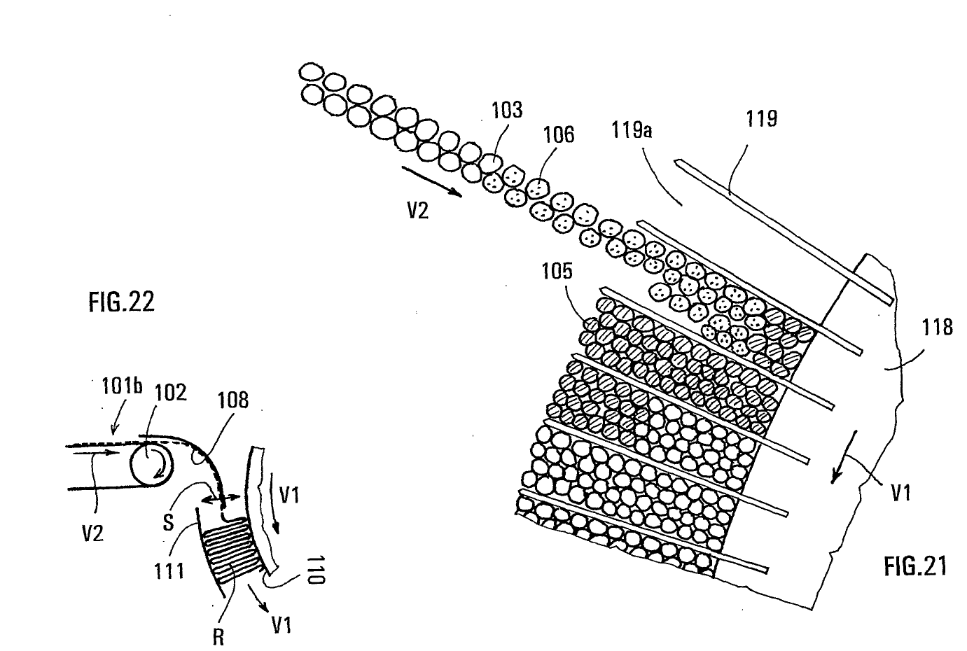

FIG. 21 is a strongly enlarged view of the detail in box E of FIG. 20.

FIG. 22 is a lateral sketched view of a detail of FIG. 10 showing the device working according to the method of FIG. 9.

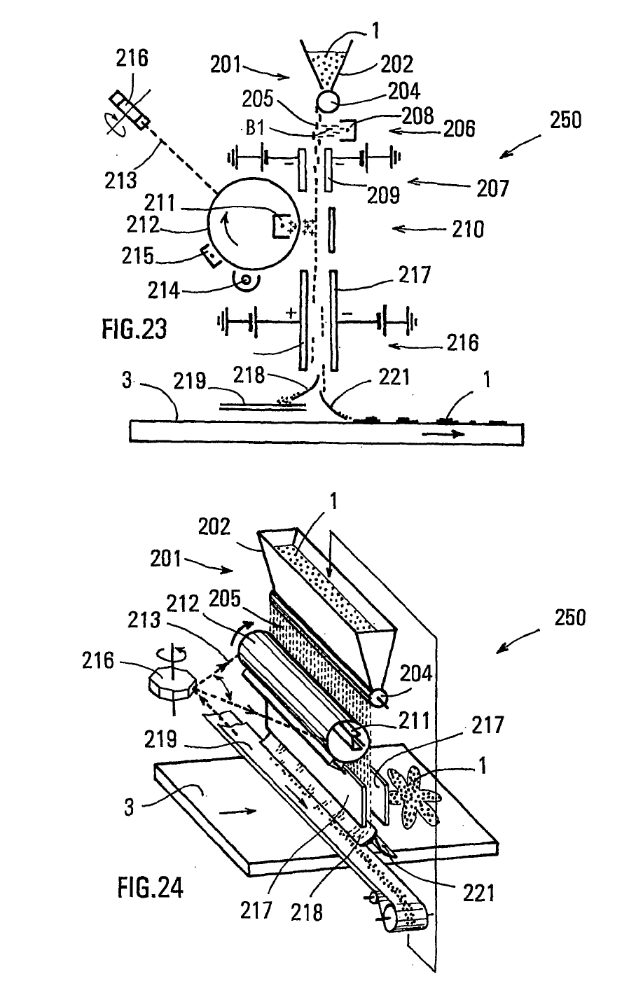

FIG. 23 is a lateral sketched view of the device according to the sixth aspect of the invention in a first version.

FIG. 24 is a perspective view of the device of FIG. 23.

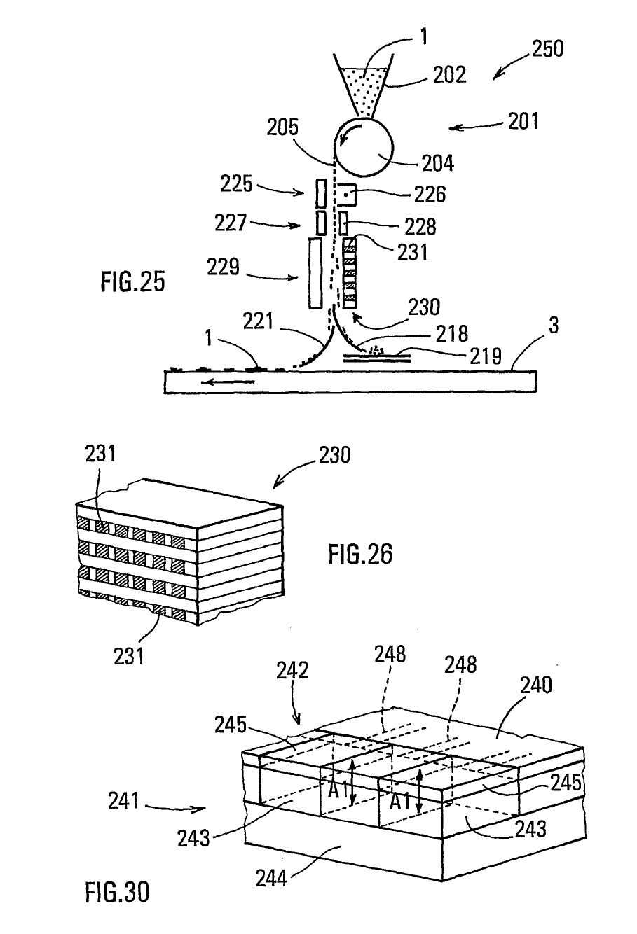

FIG. 25 is a lateral sketched view of the device according to the sixth aspect of the invention in a second version.

FIG. 26 is a perspective broken view of a detail of FIG. 25.

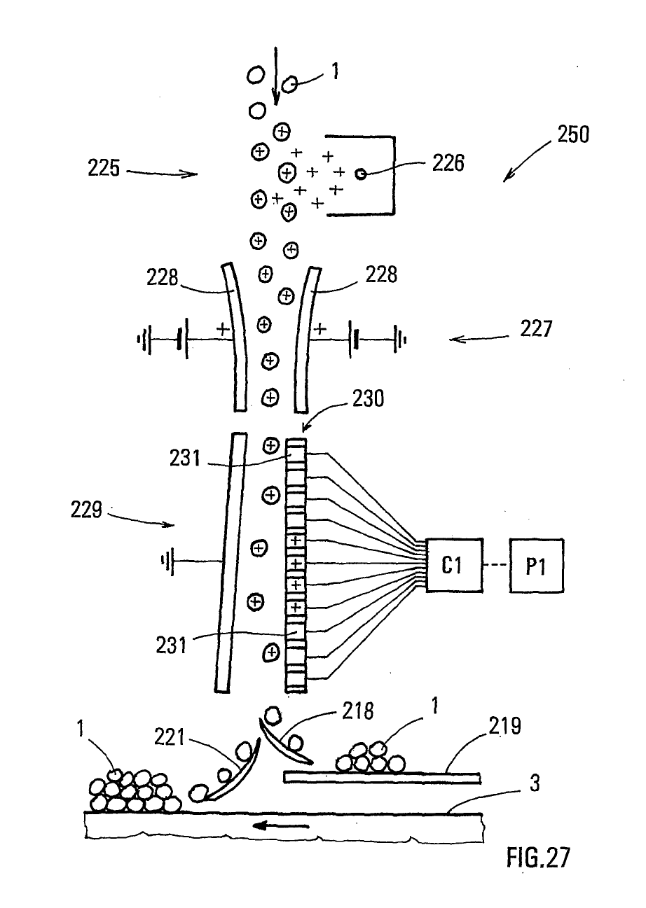

FIG. 27 is a lateral sketched view of an enlarged detail of FIG. 25.

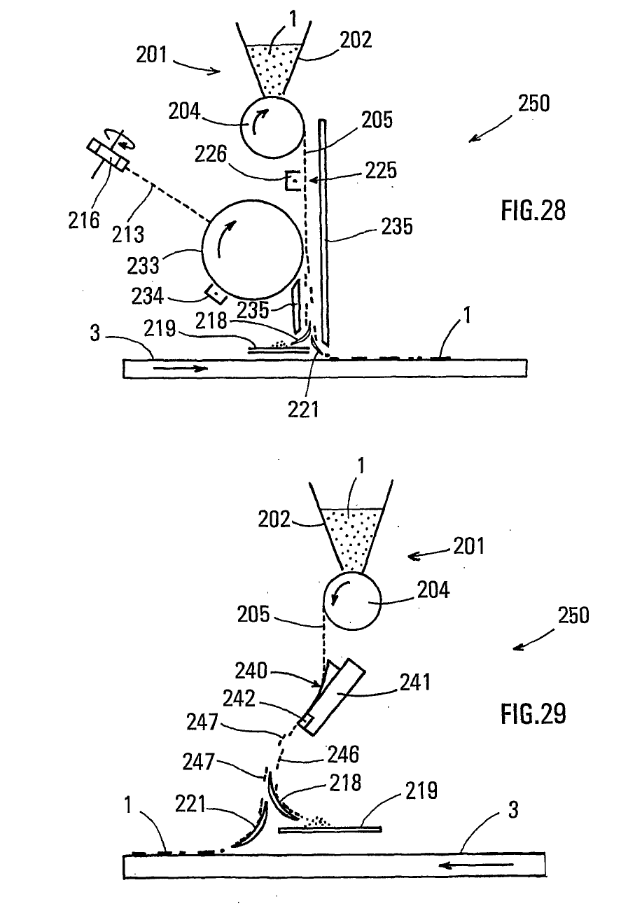

FIG. 28 is a lateral sketched view of the device according to the sixth aspect of the invention in a third version.

FIG. 29 is a lateral sketched view of the device according to the sixth aspect of the invention in a fourth version.

FIG. 30 is a perspective broken view of a detail of FIG. 29.

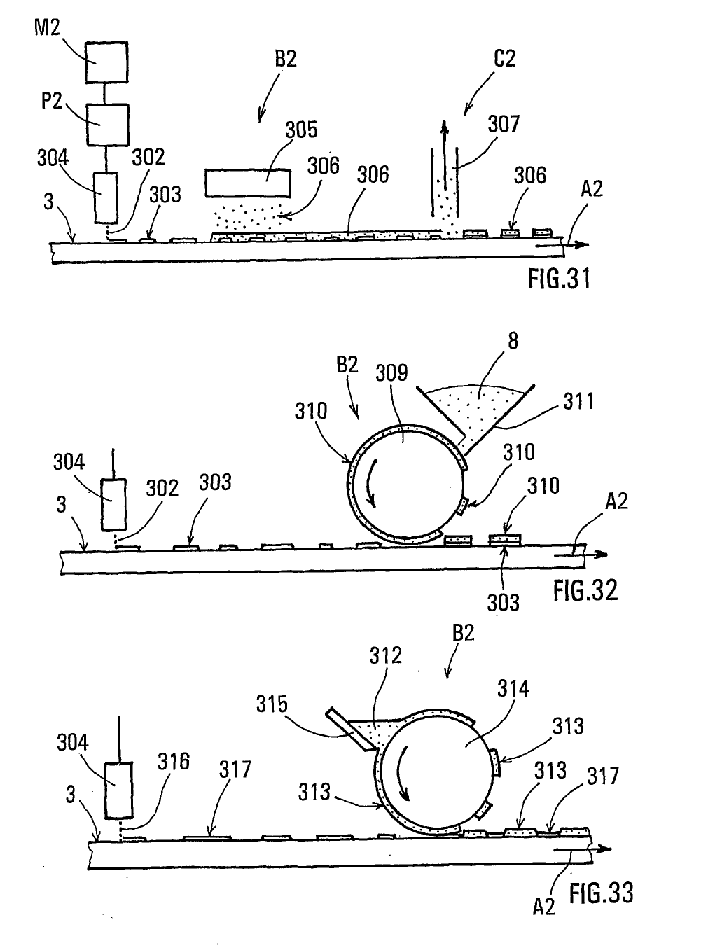

FIG. 31 is a lateral sketched view of the device according to the eighth aspect of the invention wherein decorating powdered materials are used.

FIG. 32 is a view like FIG. 31 with a different distributing system for distributing the decorating powders.

FIG. 33 is a view like FIG. 31 wherein decorating materials in a liquid suspension state are employed.

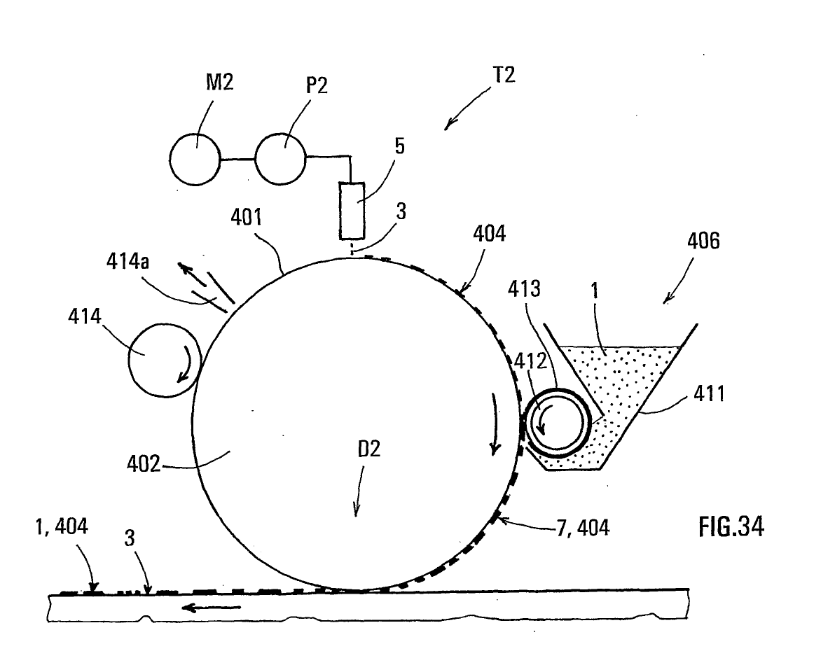

FIG. 34 is a lateral sketched view of the device according to the tenth aspect of the invention, in a version with roller transferring means.

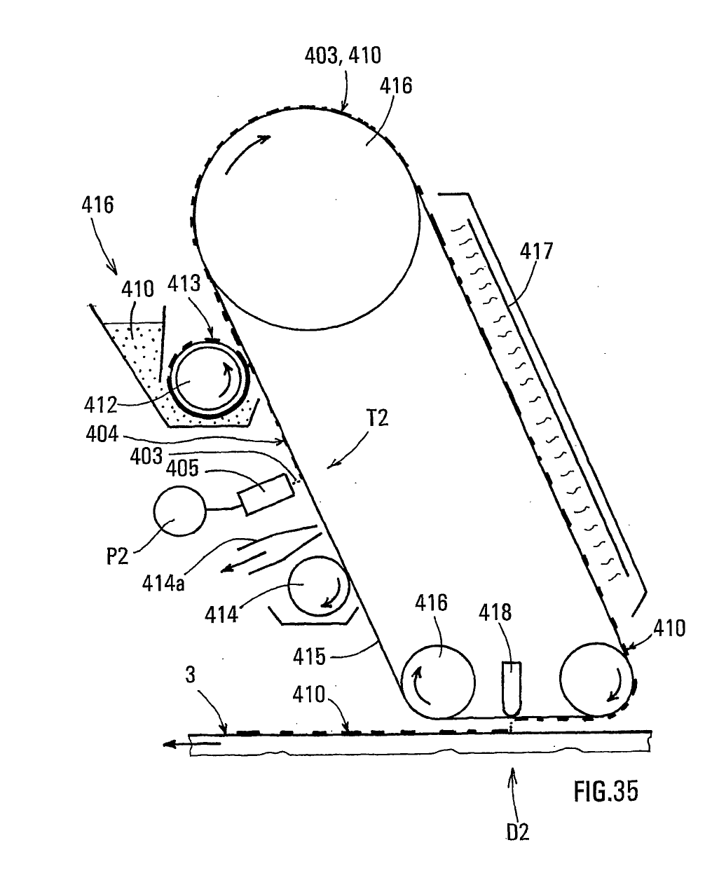

FIG. 35 is a lateral sketched view of the device according to the tenth aspect of the invention, in a version with belt transferring means.

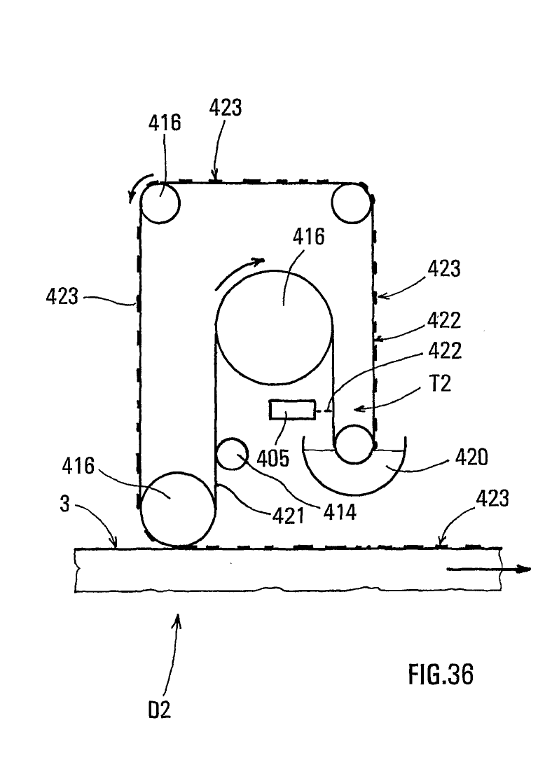

FIG. 36 is a lateral sketched view like FIG. 35 in a version with different path of the belt transferring means and with liquid suspension decorating powder.

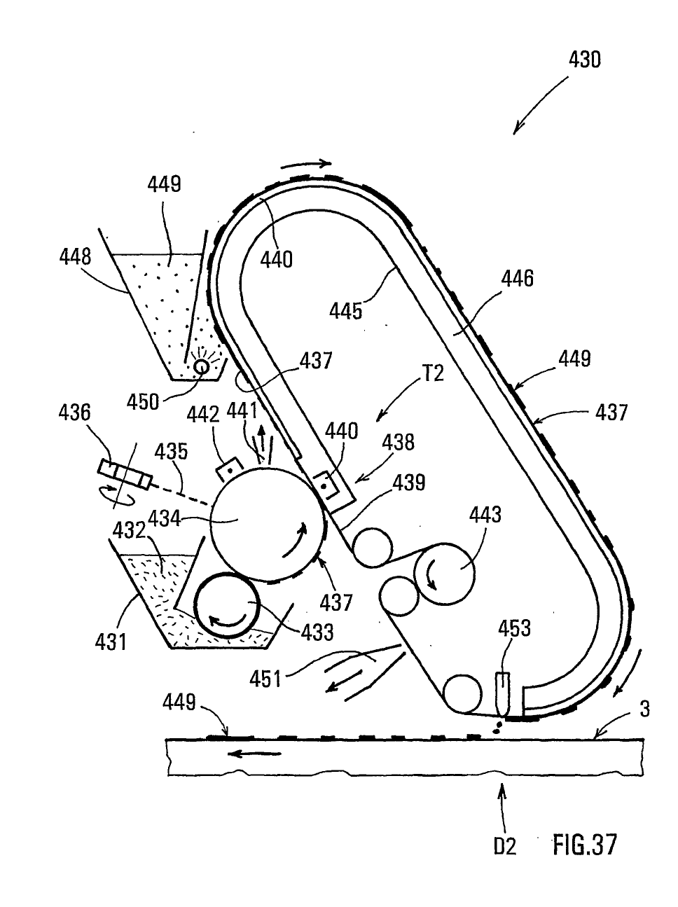

FIG. 37 is a lateral sketched view of the device according to the tenth aspect of the invention, in a version with permeable transferring belt.

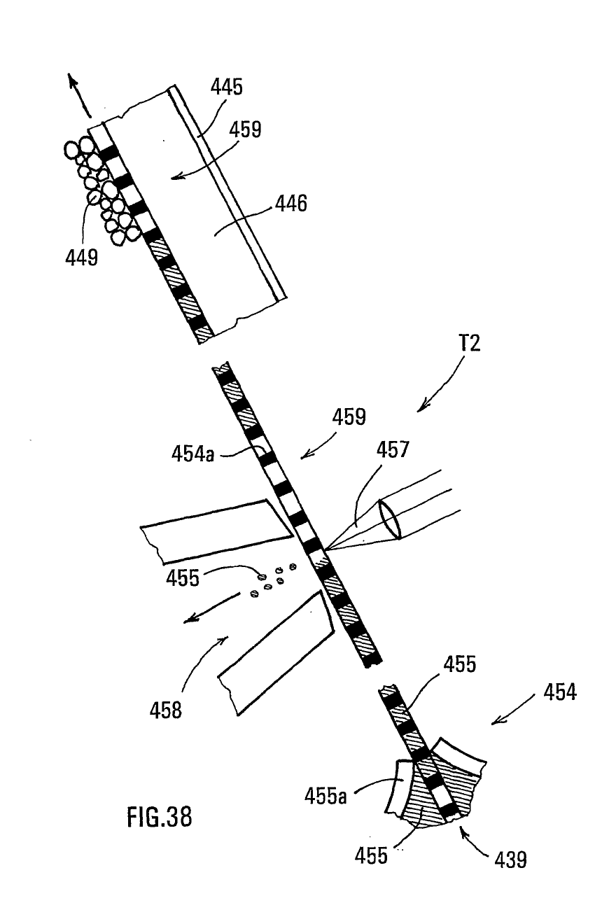

FIG. 38 is a detail of the device of FIG. 37, with permeable transferring belt, in a different embodiment.

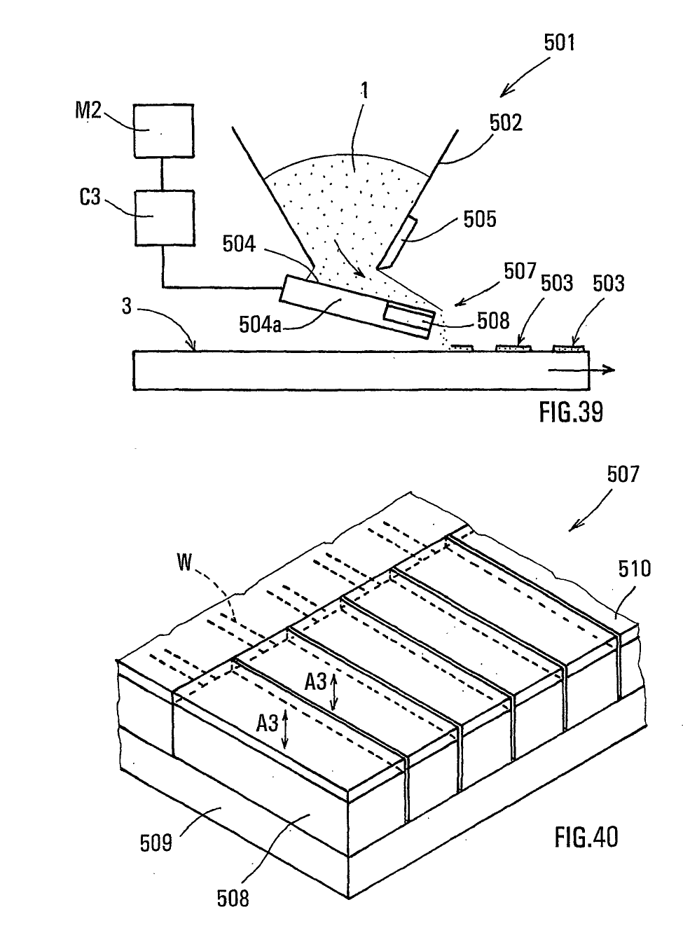

FIG. 39 is a lateral sketched view of a device for the decoration according to the thirteenth and fourteenth aspect of the invention for using granular or powdered decorating materials;

FIG. 40 is a perspective broken view of a detail of FIG. 39;

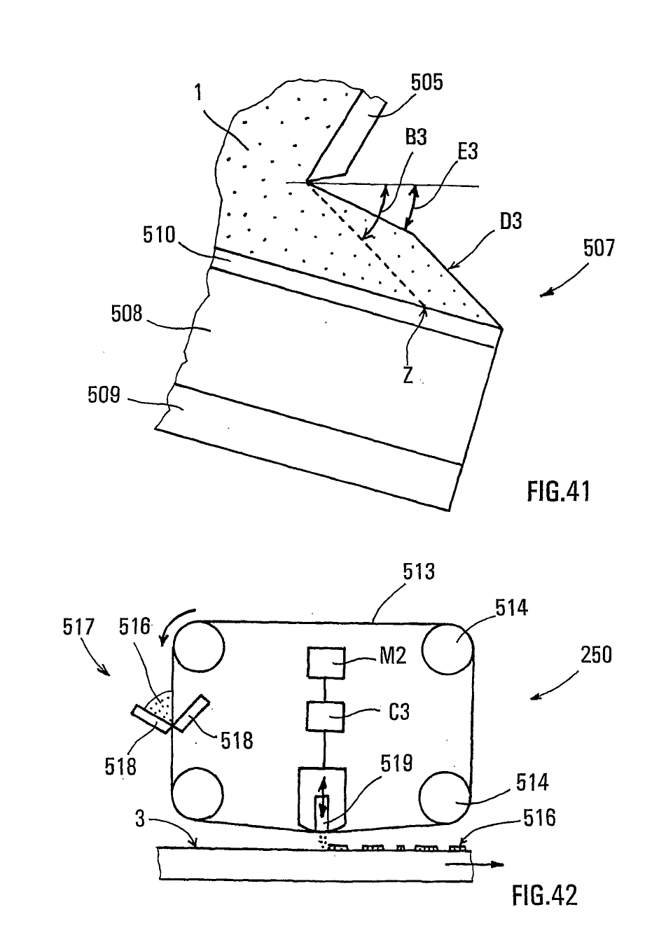

FIG. 41 is a lateral sketched view of a detail of FIG. 39 highlighting the working;

FIG. 42 is a lateral sketched view of a device for decoration according to the thirteenth and fourteenth aspect of the invention in a different version with belt transferring means;

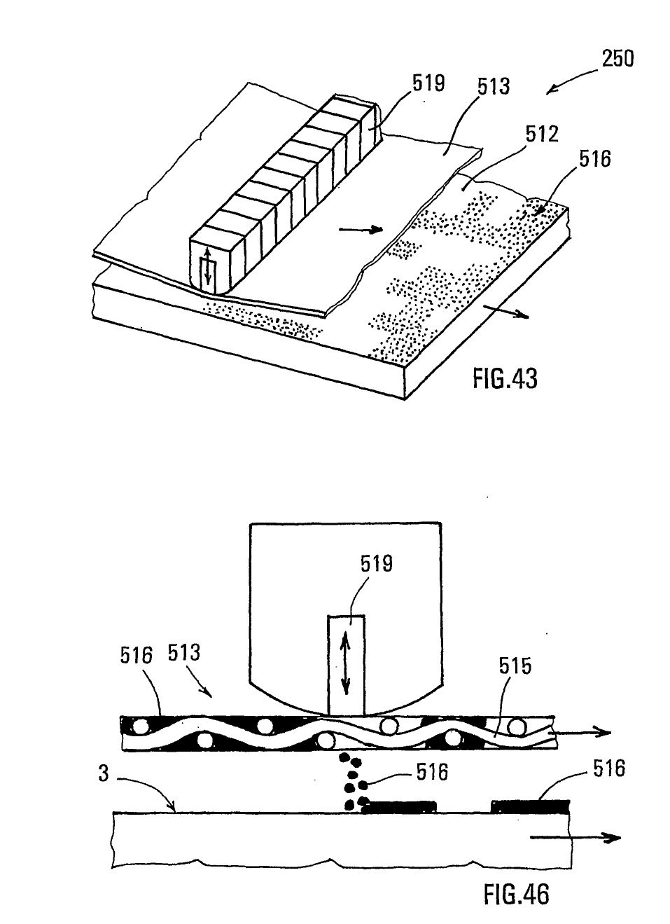

FIG. 43 is a perspective broken view of a detail of FIG. 42;

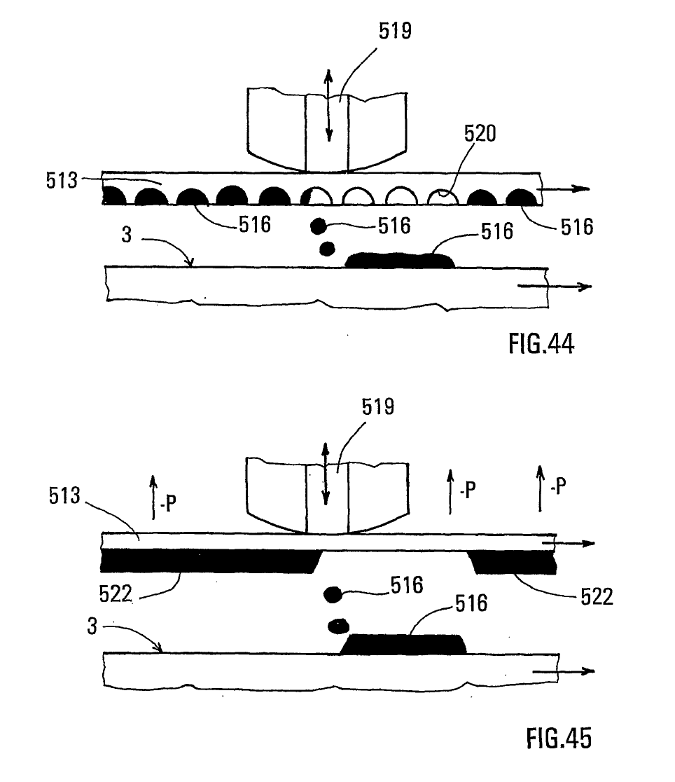

FIG. 44 and FIG. 45 are sections of a detail of FIG. 42 highlighting two embodiments;

FIG. 46 is a view like FIGS. 44 and 45, in a further variance.

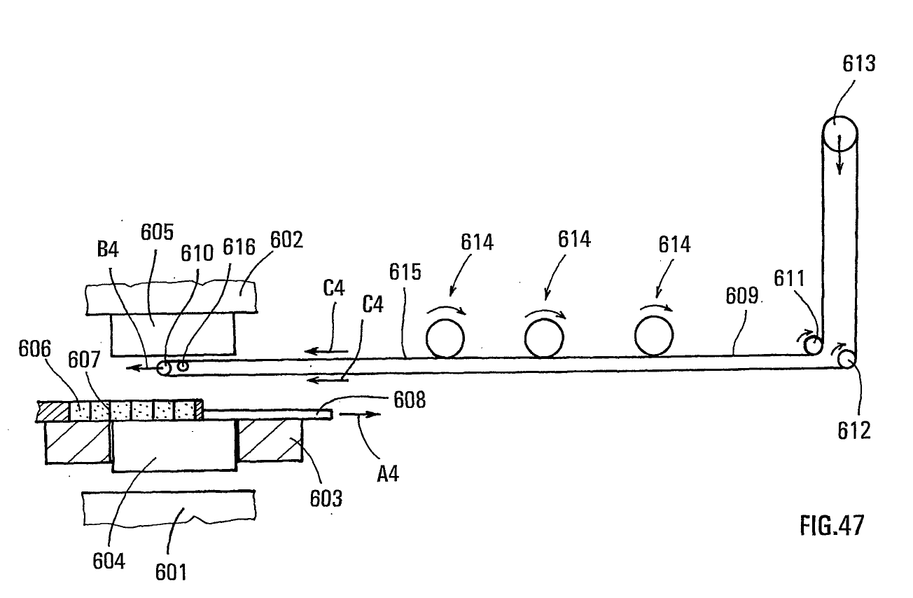

FIG. 47 is a lateral sketched view of the equipment according to the fifteenth aspect of the invention, at the end of the pressing step.

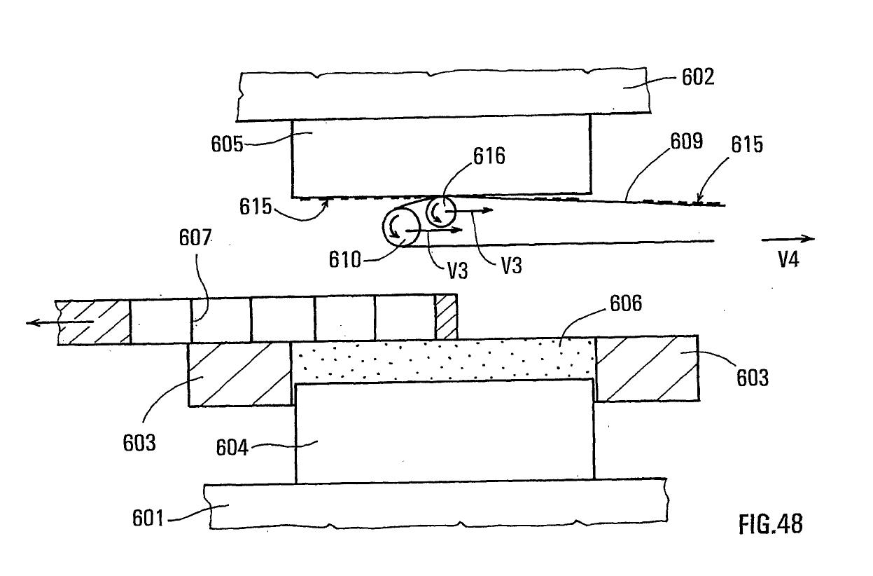

FIG. 48 is a partial view like FIG. 47, during the die filling step.

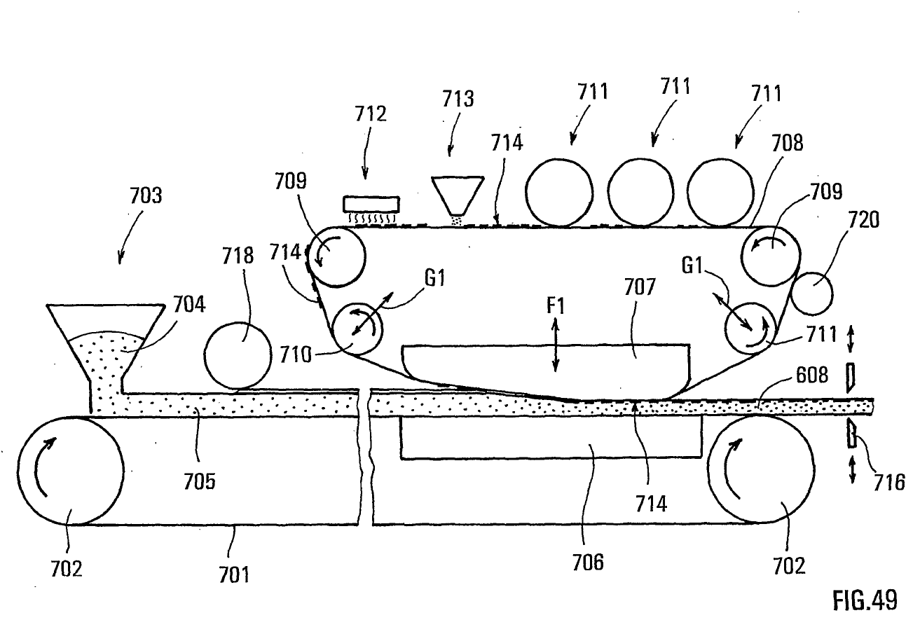

FIG. 49 is a lateral sketched view of the equipment according to the seventeenth aspect of the invention, with a continuous step-by-step pressing system;

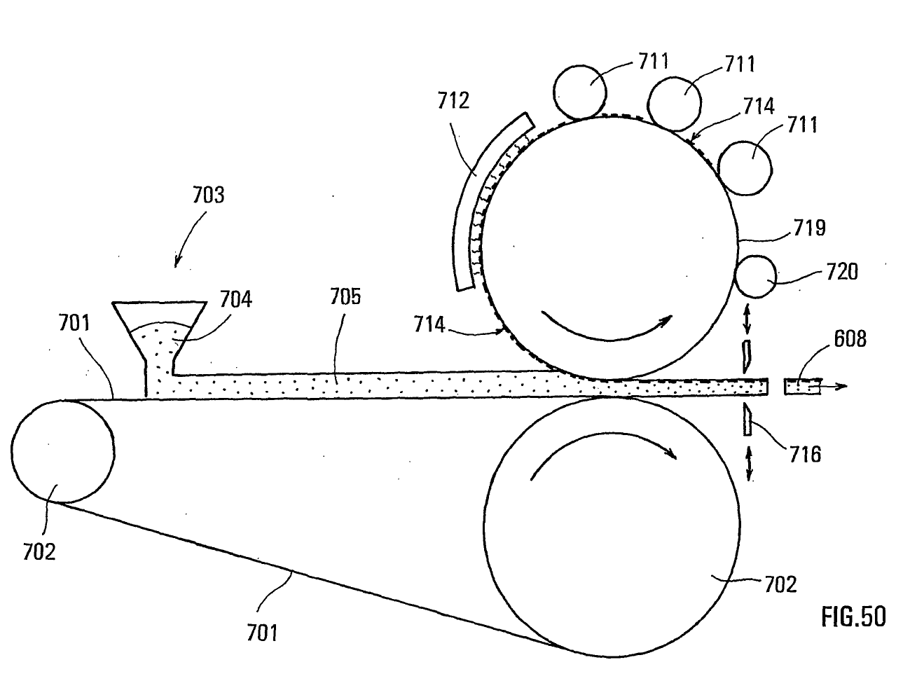

FIG. 50 is a view like FIG. 49, with a rolling rollers continuous pressing system;

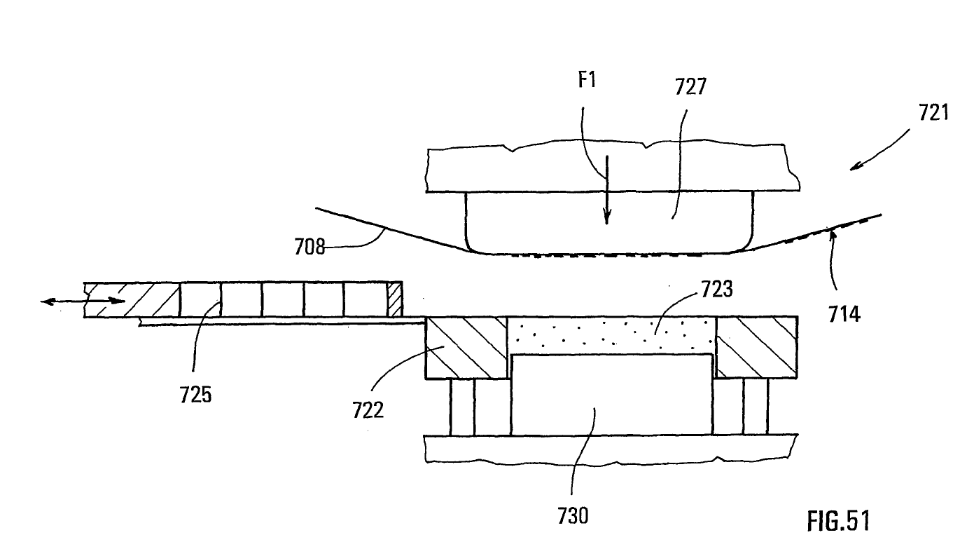

FIG. 51 is a lateral sketched view of a version of an equipment according to the seventeenth aspect of the invention using a “mirror” pressing die;

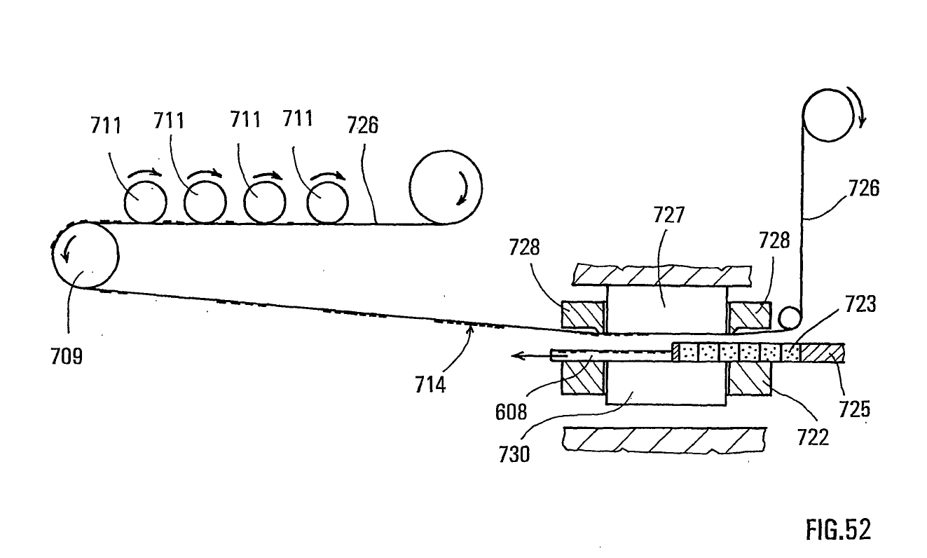

FIGS. 52, 53 and 54 are lateral sketched views of a version of an equipment according to the seventeenth aspect of the invention using a “mirror” pressing die with double lateral frame, in different working steps.

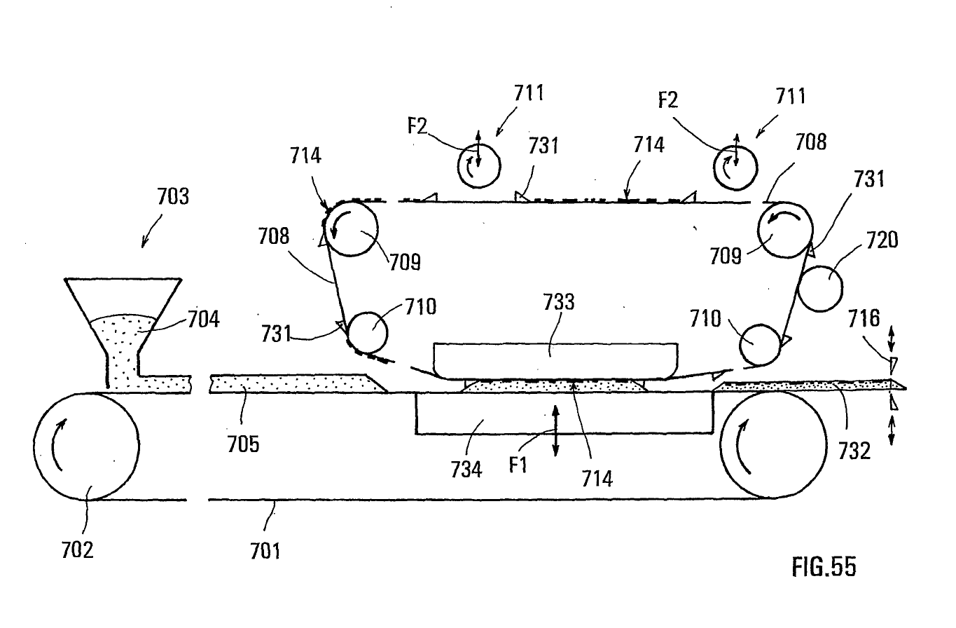

FIG. 55 is a lateral sketched view of the equipment according to the seventeenth aspect of the invention, with a pressing system similar to FIG. 49 working by single steps, i.e. wherein a whole tile is formed at each advancing step of the belt.

With reference to FIG. 1, the powdered material 1 falls freely due to force of gravity in the form of a thin layer 2 extending in a transversal plane with respect to the advancing direction A of the surface 3. During its falling path, said layer 2, flowing from not shown, known means, meets a deviation wall 4 which turns the layer 2 towards the upper branch 5 of an endless conveyor belt arranged near the surface 3 and provided with a transversal motion with respect to the direction A. In the drawing also the lower branch 6 of said belt is shown. An ejecting head 7 is arranged parallel to the layer 2, said ejecting head 7 consisting of a dense array of nozzles extending along the whole extension of the layer 2.

Said head 7, controlled by computer means not shown, projects small drops 8 of liquid along a direction crossing downwards said layer 2.

The drops 8 have a significantly higher speed than the falling speed of the powder 1, and also their mass is significantly heavier than the mass of single particles of powder 1. Said drops are therefore able to pass through the layer 2 incorporating many particles of powder 1, the direction of said drops being only slightly changed.

The drops 8, together with the powdered material 1 associated thereto, form drops 9 “loaded” with powder 1 which precisely head for the surface 3 and keep still thereon according to the programmed pattern 10 without undesirable displacements and scattering.

On the other hand, the powder 1, not embedded into the drops 8, keeps falling towards the deviation wall 4 and the belt 5 so as to be re-circulated.

For limiting the drops 8 from being slowed and their direction from being changed when passing through the layer 2, electrostatic means can be advantageously used, as shown in FIG. 1: the drops 8 are ejected out from the head 7 with a positive electrostatic charge, which persists even after the powder 1 have been embedded into the drops 8, so that, with the aid of electrodes 11, 12 the drops 8, 9 can be accelerated and deflected beyond the deviation wall 4.

In FIG. 2 a different method for conveying the powders 1 towards the drops 8 is shown: in this case the powders 1 are suspended into an air stream and conveyed by means of a conduit 13 provided with an opening shaped as a slot flowing near a corresponding suction opening 14. The air stream carrying the suspended powder 1 flows in a horizontal direction, whereas the drops 8 are projected in a vertical direction (or oblique direction). As in the previous case, separating the loaded drops 9 from the flow of powders 1 can be made easier by electrostatic means 15.

In the example shown in FIGS. 3 and 4, the powders 1 are conveyed towards the head 7 through belt means 16 to which the powders 1 adhere due to an electrostatic effect produced by suitable means 17. Near the head 7 the particles of powder 1 are forced to temporarily detach from the belt 16 through suitable blowing means 18; the, particles so detached can therefore be embedded into the drops 8 or can come back on the surface of the belt 16 due to the electrostatic effect and repeat the cycle.

The blowing means 18 can be substituted by other convenient systems, for example vibrating means (having a sonic or ultrasonic vibration frequency) or mechanical moving means; the blowing means 18 can be also omitted, in this case the drops have to move along a path tangent to the layer of powders 1. An advantage of the version described in FIGS. 3 and 4 is the constructive and working simplicity, since the belt 16 acts both as conveying means for conveying the powder 1 and as recovering means for recovering said powder 1.

Moreover, said belt 16 may be substituted by a roller.

In FIG. 5 the powders 1, having positive electrostatic charge, are conveyed through a belt 19 near the head 7, in a region where, at short distance, the end portion of a second belt 20 is present, said second belt 20 being provided with surface having negative electrostatic charge, which therefore attracts the powders 1.

Obviously, the polarities can be also inverted.

In the example shown in FIG. 6 the powders 1 are conveyed through a belt 19 and are recovered by a suction opening 14.

The drops 8 may have widely different dimensions and/or projection speed, depending on the desired definition or other needs.

Thus, for example, if a high definition and a low thickness of applied powders 1 are required, the drops 8 may even have a diameter smaller than 0.04 mm and the linear density of ejecting nozzles arranged in array may even be greater than 10 nozzles per millimetre.

The head 7 will be built according to the known principles of the ink-jet technology and will work with distilled water, other liquids or appropriate liquid solutions, for example containing surface active agents suitable for reducing the surface tension so as to help powders incorporation.

The liquid constituting the drops 8 may be kept at high temperature so as to make its evaporation easier after impacting on the surface 3, or to cause its solidification by cooling.

The evaporation or solidification of liquid constituting the drops 8 is particularly useful when the surface 3 has to be subsequently pressed, since said evaporation or solidification makes easier keeping the pressing die surface cleaned. If a significant amount of powders 1 has to be applied, the drops may even have a diameter greater than one millimetre, for example choosing ink-jet heads electromechanically controlled.

In all the described examples the powder 1 can be easily embedded into the drops 8 if the drops are provided with electrostatic charge opposite to the charge of the powder 1.

The ejection speed of the drops may range from a few decimetres per second up to even ten metres per second or more, according to the working distance of the head 7 from the powders 1 and the surface 3.

The dimensions of particles of powders 1 will be properly proportional to the dimensions of drops 8 and said powders 1 will be advantageously made of agglomerates of pseudo-spherical shape obtained by atomisation, and belonging to a quite uniform particle size range.

In a version of the invention not shown, the drops 9 and the powders 1 embedded thereinto are applied to the surface 3 together with the exceeding powders 1 not embedded into the drops 9 and said exceeding powders 1 are subsequently removed from the surface 3 for example by suction.

An advantage of said version is that particles of powders 1 having dimensions even significantly greater than the dimensions of drops 8 may be used, since the two portions of powders 1 do not need to be separated during the approaching path towards the surface 3.

In this last version the adhesion of the “loaded” drops 9 to the surface 3 is assured even if this surface is porous and has a certain absorbing power; this is advantageous if compared to the case in which drops 8 of liquid alone are initially applied on the surface 3, said drops 8 having an adhesive function for the powders 1 subsequently applied, since if the surface 3 is absorbent, when the powders 1 are applied, the drops 8 have already been absorbed by the surface 3 and therefore they can not perform their adhesive function.

The liquid ejected by the head 7 may also consist, if necessary, of a continuous flow not subdivided into drops 8, unlike all the examples shown.

The surface 3 may be the surface to be decorated but in case it may also be the surface of a means used for transferring a decoration on another surface.

Furthermore, the surface 3 may be the free surface of other incoherent powder, may be oriented in any direction and eventually may be stationary, in this case the device being movable.

More devices may be arranged in series on the surface 3, each working with powders 1 of a different colour for obtaining the most varied chromatic effects.

With reference to FIG. 7, the method according to the third aspect of the invention comprises successively preparing portions of layers 101a made of powders having different colours 103, 104, arranged adjacent one to the other (as in the drawing) or superimposed and arranging said portions of layers 101a overlapped along a direction parallel to the surface M on which the decoration in the body 104a has to be visible. The decoration appearing on said surface M is therefore the consecutive view of straight sections of each single layer 101a and said decoration will appear always identical along the whole height N.

With reference to FIG. 8, in a different version of the method according to the third aspect of the invention, it is provided preparing a continuous layer 101b made of powders having different colours 103, 104 arranged adjacent one to the other (as in the drawing) or superimposed and to “compressing” in a longitudinal direction said continuous layer 101b causing it to expand proportionally in the transversal direction. This is carried out through a translation movement at speed V2 of the initial continuous layer 101b and through a translation movement at speed V1 of the “compressed” layer, V1 being significantly lower than V2; in the example of FIG. 8 the directions of movements V1 and V2 are the same, but they may also be different, extending in any direction and with any angulation.

In the example of FIG. 9 the same result is obtained with a kind of zigzag folding carried out on said continuous layer 101b.

With reference to FIGS. 10 to 16, the device according to the invention comprises a conveyor belt 101 wound in a closed loop on rollers 102, on the upper branch of said belt 101 a plurality of stations F, G, H, I being arranged for applying decorating powders 103, 104, 105, 106.

The belt is arranged for continuously moving at a relatively high speed and, at a downstream end portion thereof, said belt co-operates with the curved lower surface of a deflector 108 suitable for deflecting the particles of decorating powders 103, 104, 105, 106 downwards in a substantially vertical direction.

The end portion of said deflector 108 is arranged close to the inlet of a space 109 having a substantially uniform thickness L, said space being defined between the lateral surface of a rotating cylinder 110 and a cylindrical wall 111 associated thereto. Said cylindrical wall 111 extends over an angle of about 90° starting from the lowest portion of the cylinder 110.

Below said rotating cylinder 110 and said cylindrical wall 111 a second belt 112 is arranged, on said second belt 112 a base layer of powders 114 being formed, continuously distributed by suitable means 113. Said belt 112, together with the base layer 114, is movable at a speed V1 significantly lower than the speed V2 of the belt 101.

During operation, since the speed V2 is relatively much higher than the speed V1, the layers of decorating powders 103, 104, 105, 106, are arranged on the belt 101 in very thin stratifications (as FIGS. 12, 13 and 14 show) and according to a highly stretched pattern in width along the direction of said belt 101, as shown in FIG. 11.

As highlighted in FIG. 13, in an extreme case the different decorating powders 103, 104, 105, 106 may even be contained in a single layer.

Due to the high speed of the belt 101, the decorating powders 103, 104, 105, 106 are projected on the deflector 108 and from there conveyed into the space 109 in the region nearest to the surface of the cylinder 110. The layer forming inside the space 109 flows at a speed V1 and, as a consequence of the different length of linear path, it tends to incline, at its free surface 115 upwards, with an inclination corresponding to the inclination of the powder sliding angle. Therefore, if the thin layers of decorating powders 103, 104, 105, 106 are caused to slide on this inclined free surface 115, said layers are continuously distributed on the whole thickness L of the space 109. Even though the decorating powders are substantially uniformly distributed on the thickness L, the definition level along the direction V1 will substantially depend on the thickness of said decorating layers 103, 104, 105, 106 on the belt 101, i.e. the definition level along the direction V1 will be as higher as thinner said decorating layers are on the belt 101. Therefore, if the ratio between the speeds V2 and V1 is high, an increase in definition, substantially proportional to said ratio, will be obtained.

Also the remixing level between the different colours will be proportionally increased according to said ratio, thus obtaining the possibility to have an unlimited range of colours by properly changing the proportions of the different colours.

When said decorating layer is laid on the base layer 114, a thick layer Q is obtained, having substantially vertical venations.

It is specified that the cylindrical wall 111 has to allow the powders 103, 104, 105, 106 to easily slide thereon and it is therefore coated with a suitable material having a low coefficient of friction, or it may consist of a moving belt having speed V1.

In the embodiment shown in FIG. 22, the deflector 108 is alternatively movable in a direction S so that the stratification 101b folds in a zigzag superimposed configuration R.

The so obtained stratification can be sent to a pressing die, taking care of avoiding powder decompositions; for this purpose the solutions shown for example in IT 1.292.654 or in the Italian patent application M098A000197 can be adopted.

For preventing decompositions, said stratification may be advantageously pressed or pre-compacted directly on said belt 112 in an intermittent or continuous way according to the solutions shown for example in WO 96/15888 or in WO 98/23424.

The decorating layer may be laid over a base layer 114 as in the shown example and as in examples of FIGS. 17 and 18, or it may be laid below a base layer as in FIG. 19, or it may constitute the whole thickness as in FIG. 20.

As far as the field of ceramic tiles is concerned, the possibility of having a tile with decorating powders arranged on a layer whose thickness is limited to values between 1.5 and 3 mm is quite advantageous, since higher thickness may be irrelevant from an aesthetic or qualitative point of view, whereas they are surely penalising from an economic point of view, due to the excessive use of expensive colouring raw materials.

The device version of FIG. 17 is different from that of FIG. 10 in that the cylinder 110 is not present and the belt 112 is actuated in the opposite direction with respect the belt 101.

FIG. 18 shows a device used for directly feeding a stationary die 116 in a cavity thereof the base layer 114 is already laid. In such case, during the filling step, the roller 102 scanning moves back at a speed V1 significantly lower than the advancing speed V2 of the belt 101. After the cavity has been filled, the device remains stationary for allowing pressing, then it is advanced towards the opposite end of the die when said die has been emptied and another filling cycle is repeated.

Such device may also be used for filling a movable die; in this case the roller 102 will remain stationary while the underlying die 116 will move at a speed V1.

In FIG. 19 a device is shown without the deflector 108 and having a belt 117 whose lower branch abuts on said powders and moves synchronously with the belt 112. Said belt 117 has the function of keeping the powders in place.

The device shown in FIGS. 20 and 21 comprises a cylinder 118 the surface thereof is provided with a plurality of partitioning walls 119, forming spaces 119a, densely arranged in radial rows parallel to the rotation axis. Said partitioning walls 119 have the function of keeping the various layers of decorating powders divided and of arranging them on the belt 112 with the proper orientation.

It is noted that, with respect to prior art as described in patents U.S. Pat. No. 5,368,791, U.S. Pat. No. 5,54,393, U.S. Pat. No. 5,736,084 and EP 0974437, the just described embodiment offers some decisive advantages: first of all partitioning walls perpendicular to said walls 118 are not present since remixing along the axis parallel to the rotation axis is not possible, as spaces between the partitioning walls 118 are simultaneously filled; this makes the device simpler from a mechanical point of view and allows an easier powder movement, which allows said walls 118 to be brought nearer for obtaining higher definition. Furthermore, means for powder remixing is not required since powders are already arranged as thin layers, substantially remixed.

It is noted that the invention allows the drawing definition to be improved, even though there is a high decoration thickness, and that the drawing definition is improved not only in the belt movement direction, but also in all the other directions, as it will be explained below.

Suppose a complete layer of decorating powders having a thickness of 3 mm needs to be laid with mutual remixing and according to the technique known as described in the patent application for industrial invention RE96A000004: said layer will be laid on a belt, for example according to a square pattern with a side of 10 mm; obviously, since the powders are unbound, they will extend on an inclined plane depending on the sliding angle. If the sliding angle is supposed to be a 45° angle, the powders will extend for about 3 mm all around the square. When subsequently passing through the mixing deflectors and being laid on the final surface, such extension is expected at least to double and, in the most favourable hypothesis, the square of 10×10 mm will become a square of 22×22 mm having rounded angles (nearly a circle having a gradually shaded border).

Suppose now the same square of decorating powders having a thickness of 3 mm is laid with the method according to the present invention: if the speed ratio is supposed to be V2/V1=6, on the belt 1 a powder layer 0.5 mm high will be laid according to a rectangular pattern of 10×60 mm, the extension due to sliding will be of 0.5 mm and the rectangle will assume dimensions of 11×61 mm; when passing on the surface having low speed the dimensions will become roughly 11×10.2 mm (the measure 10.2 comes from 61/6). The improvement with respect to prior art is evidently remarkable.

In a version of the invention, not shown, it is provided arranging said stratification of decorating materials by distributing first a thin, substantially uniform layer of not coloured material, colouring it with one or more subsequent dye applications and then carrying out the transferring in the body 104a in a previously described method. In such process a liquid solution could be used as a dye and this would have the advantage that, if compared to the known technology using such colouring solution, the dye would be more distributed in depth and less laterally expanded; furthermore, such colouring solutions could be applied through a computer controlled ink-jet technique, with sure further advantages.

In a further version of the invention, not shown, after arranging said stratification, pre-compacting the stratification is provided; this allows a more orderly transferring, particularly if transferring is made by steps as shown in FIG. 7.

The distributing means for distributing decorating powders 103, 104, 105, 106 can be of any known type, such as, for example: fixed screen means reciprocatingly working, rotating screen means, means with roller or belt distributor, vacuum co-operating screen means as described in the Italian application M098A000196 etc. However, the invention power is enhanced if combined with the possibility of applying said decorating powders according to patterns real time controlled by computer means.

With reference to FIGS. 23 and 24, the device 250 consists of a feeder 201 comprising a hopper 202 containing the powder 1 and an underlying rotating roller 204.

The rotation of roller 204 creates a flow of powder 1 having the shape of a thin layer 205 free falling due to the force of gravity. During the falling path the thin layer 205 passes through an electrostatic charging station 206 consisting of a flow of negative ions B1 emitted by a thin wire 208 kept at high negative tension.

In a subsequent alignment station 207, the thin layer 205 passes through a pair of plates 209 negatively charged like the powder 1; therefore said thin layer, due to repulsion, will tend to align in a central region equally spaced from plates 209.

The so aligned thin layer 205 keeps falling until it arrives to a station 210 for selective electrostatic charging comprising a source of positive ions 211; before reaching the powder 1, said positive ions 211 pass through a photosensitive screen 212.

Said screen 212 consists of a thin grid, having the shape of a rotating drum which influences the passage of said flow of ions 211 depending on how the screen surface was sensitised by the laser beam 213.

Said laser beam 213 is modulated and reflected by the prismatic rotating mirror 216 and scans the whole extension of the screen 212 so as to form thereon the desired pattern. A lamp 214 for removing residual charges and an element 215 for recharging the screen surface are furthermore arranged around the screen 212.

The device for selective electrostatic charging of station 210 here described is known in the field of ionographic printers and is described more in detail, for example, in the patents U.S. Pat. No. 4,600,292 and U.S. Pat. No. 4,804,980.

After passing through the station 210 a portion of the powder 1 is still negatively charged whereas the other sensitised portion has a neutral charge (of positive, or having a low negative value, depending on the intensity of the source 211) and therefore, when subsequently passing through the electric field 216, generated by a pair of plates 217, the powder is subjected to a selective deflection according to its the charge: a portion of powder 1 captured by a deflector 218 is unloaded on a belt 219 whilst the other portion flows on the moving surface 3.

The belt 219 is provided with transversal movement with respect to the movement of the surface 3 and conveys the powder 1 towards other means, not shown, suitable for recycling the powder inside the hopper 202.

Advantageously, the powders 1 converging on the surface 202 are accompanied on a canalising means 221 for reducing their impact speed and giving them a motion concordant with the motion of surface 3.

In FIG. 24, for simplification, the station of electrostatic charging 206, the alignment station 207 and the lamp 214 are not shown.

In the device shown in FIGS. 25, 26 and 27, the powders 1 are initially electrostatically charged with positive charge in a station 225 through an ionic source 226.

In a subsequent station 227 the particles of powders 1 are caused to align by passing through two plates 228 positively charged which, for repulsion, convey the particles 1 in a central region equally spaced from said plates 228.

The selective deflection of the thin layer 205 of powders 1 is subsequently obtained by properly modulating the electric field 229; such modulation is achieved with the use of a plate 230 subdivided in a plurality of electrodes 231 which are singularly controlled by computer means P1 through a converter C1 converting the digital signal into an analog signal.

Advantageously, said electrodes 231 are also arranged in a plurality of levels so that, for example, the deflection impulse acting on a single grain of powder 1 is carried out at each level during its falling path without affecting the deflection of other grains placed upstream or downstream.

This allows a quite large deflecting electric field to be used even if a good drawing definition is kept.

The electrodes 231 may be successively controlled starting from a null potential up to a positive potential and vice versa, or starting from negative potential up to positive potential and vice versa; in this second case the deflection gap is increased since the particles of powder 1 which have to converge on the surface 3 will be deflected towards a direction while the other particles 1 will be deflected in an opposite direction.

In the device of FIG. 28, as in FIG. 25, the powders 3 are first electrostatically uniformly charged in a station 225 through a source of ions 226.

The selective deflection is here obtained by tangentially approaching the thin layer 205 to a roller 233 having a surface electrostatically charged in pre-established regions.

Said roller 233 has a photoconductive surface which is charged by the ionic source 234, then the regions exposed to the laser beam 213 become conductive and are discharged on an underlying layer of the roller 233.

A surface having charged regions is therefore approached to the thin layer 205, said charged regions slightly deflecting the path of the thin layer 205 due to attraction (or repulsion, according to the polarity of the electric charge).

In order to increase the deflection level, two rollers 233, opposed to the thin layer 205, may be used, said rollers being electrostatically charged with charges of opposite sign distributed according to a mirror pattern in synchronised movement, for concurrently acting on powders 1; a plurality of rollers 233 arranged in cascade may also be provided.

Said rollers 233 may have a photoconductive surface directly sensitised by the laser beam 213 as in the example shown, but also may also be not photosensitive and be indirectly charged by another photosensitive roller through a ionographic technique, as described for example in the already mentioned patent U.S. Pat. No. 4,804,980.

Since the achievable deflection is quite small, convenient guards 235 need to be provided, for preventing random deflections of the thin layer 205 due to air flows; furthermore, also in this case an alignment station 227 for aligning the thin layer 205 will be preferably present, as in the preceding example.

Advantageously the powders 1 will consist of grains of quite uniform size, for avoiding a different behaviour as regards the deflection angle and the falling speed due to different grain size. The best results are achieved with a powder having a thin but loose grain size, such as for example pseudo-spherical grains with a diameter ranging from 0.12 to 0.15 mm.

With reference to FIGS. 29 and 30 the thin layer 205 of powders 1 is caused to slide on the surface 240 of a plate. Said surface 240 ends in its lower portion with a plurality of elements 242 capable of vibrating, if activated.

Such elements 242 consist of a set of bodies made of piezoelectric material 243 welded between a base electrode 244 and a set of upper electrodes 245.

Said electrodes 244, 245 are connected to control means controlled by computer P1 and therefore each element 242 may independently vibrate along a direction A1 perpendicular to the surface 240.

A grain of powder 1 lying on a not vibrating element 242, will not be subjected to any displacement and will follow the most internal path 246 until said grain is captured by the conveyor 218 and conveyed on the belt 219; on the other hand, a grain of powder 1 lying on a vibrating element 242 will follow a more external path 247 and will be conveyed on the surface 3, since it receives a slight push.

Position and inclination of plate 241 will be properly adjustable for adjusting working conditions according to different powders and different requirements.

The device is extremely simple, effective and exact: for example, the elements 242 may have a width and a length even quite small for achieving a greater definition in feasible drawings; however, this does not compromise the flowing freedom of powder 1 which does not have to pass through small openings.

The flow rate of powder 1 may be furthermore easily controlled by properly varying the flow rate of the feeder 201.

Also in this case the best results are achievable by using micro-granulated and highly loose powders 1, however the device may work also with quite rough granular material or quite thin powder. The energies needed for moving the powder 1 are very small and the plate 241 may therefore consist of a single board, the vibrating elements 242, the printed electric circuits 248 and the converters digital/analog being integrated therein.

The vibrating frequency may be widely varying and can range from sonic to ultrasonic field according to the requirements.

The space between the vibrating elements 242 may be advantageously be filled with suitable elastomeric material for preventing powder 1 from penetrating in said space.

For this purpose a simple surface coating film may also be provided, said film performing also other functions, such as for example: anti-wear, anti-friction, anti-adherence.

The invention is not restricted to the described forms but can be carried out, according to the claims, also in other manners.

The deviating device may also consist, for example, of a set of small air ejecting nozzles oriented transversely to the flow; similarly, the deviating device may also consist of a laminar air stream transverse with respect to the flow, modulated by the passage of a moving screen having permeable and not permeable regions.

The deviating device may also consist of a plate similar to the plate 241 of FIG. 29, wherein the elements 242 may be caused to change their inclination, instead of vibrating.

The selective electrostatic charging device 210 can be carried out in any other way, for example with a system of electrodes directly contacting the powder 1.

Also the station 225 for uniform electrostatic charging may be constituted by systems directly contacting the powder 1.

The feeder means 1 may be carried out in any other way and the thin layer 205 of powders 1 may be also oriented in any other direction, using a suitable feeder 201.

With reference to FIG. 31, on the surface 3 of the tile to be decorated an adhesive liquid product 302 is projected on selected regions 303. Said adhesive liquid product 302 is projected from a head 304 made of an array of nozzles spaced by a step allowing the drawing desired definition, the system is controlled by microprocessor P2 and memory M2 according to known digital techniques.

Said head 304 may be stationary, provided with ejecting nozzles transversely aligned with respect to the advancing direction A2 of the surface 3 and may cover the whole width of the surface 3 to be decorated, or may be provided with ejecting nozzles aligned parallel to the advancing direction A2 and may be moved scanning transversely with respect to the advancing direction A2.

Downstream, in a distribution station B2, a device 305 is initially present, suitable for laying a layer 306 of decorating powdered material on the whole surface 3 of the tile and then, in a separating station C2, a suction device 307 is present, collecting the decorating material 306 not contacting the adhesive material 303. Instead of suction device 307, a slight blowing may be also adopted for removing the powders from regions where the adhesive material 303 is not present to regions where said product is present.

In FIG. 32 the decorating powdered material 1 is distributed by a roller 309 covered with a layer 310 of said material 1; the layer 310 is moved close to the whole surface 3 of the tile but is applied only to the regions thereof where the adhesive material 303 is present, due to adhesion. The decorating powder 1 is kept adhering to the surface of roller 309, advantageously since vacuum is present, acting on powders through the permeable surface of the roller 309. The layer thickness is continuously reintegrated by a hopper feeder 311.

With reference to FIG. 33 the decorating material, which in this case is in a liquid or pasty state, is distributed as a layer 313 on a roller 314 by a scraper 315 slightly spaced from the roller surface 314.

The head 304 applies on the surface 3 detaching liquid materials 316 (water repellent) arranged in selected regions 317, and therefore, the layer 313 is transferred to the surface 3 only in the regions where this water-repellent material 316 is not present.

Unlike the version shown in FIG. 31, in versions shown in FIGS. 32 and 33 the decorating material 1, 312, is automatically removed from the surface 3 by means of the roller 309, 314, in the areas where said decorating material 1, 312, does not adhere to the surface 3.

In the particular case of working ceramic tiles, the surface 3 may be the surface of an already fired tile, the surface of an already formed, but not yet fired, tile, the surface of a belt used as pressing means as described in PCT-EP95-04560, or the surface of a punch of the pressing die.

Said first material 302, 316 is applied on the surface 3 as small distinct drops, however said small drops, when adjacent, may also get together in a continuous region.

The adhesive material may simply consist of distilled water, ethylene glycol, but it may also include any other liquid, more or less viscous, organic or inorganic, solutions, mixtures, oils or other, and it may even comprise solid phases if this is useful for the result.

The anti-adherent material (water-repellent) may be applied in its liquid state, keeping it at a suitable temperature when passing through the head 304 and causing it to solidify by cooling when contacting the surface 3 of the tile.

Anyway, said adhesive and anti-adhesive materials may be applied with other computer controlled known means; furthermore, they may be advantageously applied as “pixels” of variable size and distances, by properly varying the jet intensity and frequency, so as to increase definition and shading effects.

It is noted that, if compared to known techniques, the invention allows the an amount of decorating material 306, 312 to be applied, said amount being significantly greater than the amount of material 302, 316 (adhesive and anti-adhesive) passing through the head 304.

The grain size and abrasive properties of the material 302, 316 passing through the head 304 are also completely different with respect to properties of the applied decorating materials 306, 1, 312, which means that, even if rough and highly abrasive decorating materials are applied, only a not abrasive liquid substantially passes through the head 304, which assures long lasting and reliable working.

A further advantage is that decorating materials 306, 1, 312 may be changed without changing the material passing through the head 304.

With reference to FIG. 34, in a treatment station T2, an adhesive liquid material 403 is applied as small drops 404 on the surface 401 of a transferring means consisting of a roller 402, said small drops 404 keeping distinct one from the other on the surface 401 or, if adjacent, getting together for forming a continuous region. Said adhesive liquid material 403 is applied by first means consisting of a head 405 made of an array of ejecting nozzles whose distance allows the desired drawing definition, the system being controlled by microprocessor P2 and memory M2 according to known digital techniques.

Said head 405 may be stationary, and in this case the nozzles array is aligned parallel to the rotation axis of roller 402 and the array length covers the whole length of the roller 402, or the head 405 may be scanningly movable, parallel to the rotation axis of the roller 402, and in this case the nozzles array is aligned parallel to the rotation direction of the surface 401.

Downstream, along the rotation path of the roller 402, second means is present consisting of a feeding device 406 for feeding decorating powders 1, said feeding device 406 comprising a hopper 411 and a feeding roller 412.

Said feeding roller 412 is arranged so as to bring a thin layer 413 of powders 1 close to the surface 401 of the roller 402, advantageously at synchronous speed with respect to the roller 402. For obtaining an uniform layer 413, the roller 412 may have a properly knurled surface, or it may have a tubular shape with porous external wall through which a suitable internal vacuum pressure operates: thus the powder layer 413 is kept on the external surface of the feeding roller 412, said layer 413 being subsequently transferred to the surface 401 in the areas where adhesive materials 403, 404 have been applied. In the lower portion, at a decorating station D2, the roller 402 rollingly contacts the surface 3 to be decorated and the decorating materials 1, together with the residual adhesive material 404, are transferred to the surface 3 to be decorated.

The surface 401 of the roller 402 is then properly cleaned by suitable brushing means 414 and suction means 414a.

The device shown in FIG. 35 is different from that of FIG. 34 since the transferring means consists of a belt 415 wound in a closed loop on rollers 416. An advantage of such version is that the device may be better suited for transferring decorating materials 410 on the surface 3 without contact.

In this case drying devices 417 and vibrating means 418 (also ultrasonic) are advantageously present, said drying devices 417 being suitable for evaporating the adhesive materials 403, 404. This last version of decorating device without contact may be advantageously used when the surface 3 to be decorated is incoherent, as for example the surface of ceramic tiles in a powdery state before pressing.

Instead of the feeding roller 412, a blower immersed in the powder 410 may be also used, said blower moving the powders and causing them to contact the roller 401 or the belt 415, by creating a slight upwards air flow; the same function may also be performed by a vibrating element immersed in the powder 410.

The device of FIG. 36 is suited for working with decorating materials in liquid suspension 420; in this case the head 405 applies on the belt 421 a material 422 having anti-adherent properties, said material 422 preventing the adhesion of liquid suspension 420 in the regions of belt 421 where it is applied. A thin layer 423 of decorating material in a liquid state remains therefore on the belt 421, arranged in complementary regions with respect to regions where the material 422 has been applied. The decorating material 423 may be transferred to the surface 3 by direct contact, as shown in FIG. 36, but it may also be transferred without contact by using the vibrating means 418 and the possible drying means of FIG. 35.

The adhesive material 403, 404 may simply consist of distilled water, but may also comprise any liquid more or less viscous, organic or inorganic, solutions, mixtures, oil, ethylene glycol or other. The anti-adherent material 422 may be applied in a liquid state, keeping it at a proper temperature when passing through the head 405, and may be solidified by cooling when contacting the transferring means 401, 415 421.

However, said adhesive and anti-adhesive materials may be applied with other known computer controlled systems, furthermore they may be advantageously applied as “pixels” of variable size and/or spacing, by properly varying the jet intensity and frequency, so as to increase definition and shading effects.

It is noted that, with respect to known techniques, the invention allows an amount of decorating material 1, 410, 420 to be applied, said amount being significantly greater than the amount of material (adhesive or anti-adhesive) passing through the head 405.

Also the grain size and abrasive properties of the material passing through the head 405 are completely different to the properties of the applied decorating materials 1, 410, 420, i.e., even though rough and highly abrasive decorating materials are applied, only a liquid and not abrasive material passes through the head 405, which assures a long lasting and reliable working.

A further advantage is that the decorating materials can be changed without changing the material passing through the head 405.

With reference to FIG. 37, the decorating device 430 consists of a first container 431 which contains a powder 432 suitable for being picked up in 's the shape of a thin layer by the external surface of the roller 433. A roller 434 has photoconductive surface and, during its rotating motion, is scanningly exposed to a laser beam 435 properly modulated by known means not shown and reflected by the rotating prismatic mirror 436.

The regions unexposed to laser beam 435 remain electrostatically charged and, when passing near the roller 433, are coated with a layer 437 of powder 432.

Near the region 438 the layer 437 is transferred on the external surface of the permeable wall 439; such transferring is made easier by the device 440 which exerts an electrostatic attraction on the powder 432 and is also made easier by a negative pressure acting on the opposite side of the permeable wall 439.

The surface of the roller 434 is cleaned from possible residuals of powder 432, 437 through a sucking means 441 and electrostatically recharged by the device 442.

The permeable wall 439 consists of a thin reticular tissue shaped as a belt wound in a closed loop, said belt sliding in contact with a permeable plate 444, actuated by moving means 443.

Said permeable plate 444, together with another impermeable wall 445, defines a chamber 446 inside which a suitable vacuum is kept with known means, not shown, and extends from the region 438 to the lowest region of the decorating device 430 near the surface 3 to be decorated. In the rising section of the permeable wall 439, after the region 438, a hopper 448 is present containing the decorating granulated material 449, said hopper 448 is downwards open and allows the decorating granulated material 449 to be continuously in contact with the permeable wall 439, such contact being made easier for example by blowing means 450 moving the decorating material 449.

During the upwards movement the permeable wall 439, due to vacuum, attracts and keeps adherent to its surface a certain layer of decorating granulated material 449, but this may happen only in the regions still free from the layers 437, said layer 437 inhibiting the vacuum effect by closing the porosities of the permeable wall 439. Therefore, on the permeable wall 439 a pattern is formed, consisting of a layer of decorating grains 449 which corresponds to the latent image scanned by the laser beam 435, the thickness of the layer of decorating grains 449 being easily controlled through the vacuum level.

In the lowest portion of the distributing device 430, where the chamber 446 is no more present, the decorating granulated material 449 lays automatically on the surface 3, which is also synchronously moving, according to a plan arrangement corresponding to the image scanned by the laser beam 435.

Subsequently, a suction means 451 collects the possible residuals of powders 432 and/or grains 449. The powders 432, for having a high occluding power and being easily electrostatically attractable, will be advantageously based on lamellar materials, such as for example talcum, mica, gypsum, etc. properly electrostatically charged.

It is noted that, depending on the type of powders 432 and other factors, said powders 432 may be applied on the surface 3 in the regions complementary to the decorating granulated material 449, or may stay adherent to the permeable wall 439: in the first case said powders 432 will become integral part of the surface 3 and will possibly constitute a decorating material; in the second case said powders 432 will be instead sucked by the means 451 and possibly properly recycled, together with those sucked by the sucking means 441. The decorating material 432, 449 may be applied on the surface 3, according to needings, with contact or without contact between the decorating device and the surface 3 to be decorated.

The decorating materials 432, 449 may be more easily detached by further means, such as vibrating devices 453, vibrating at with sonic or ultrasonic frequency, arranged in contact with the internal portion of the permeable wall 439.

This version of decorating device 430, provided with permeable wall 439, may also be carried out with a different type of applicator for applying the occluding layers 437: such applicator may consist of the head 405 which, as previously described for the anti-adherent material 422, projects occluding material in a liquid state at a suitable temperature, said material then solidifying by cooling after contacting the porous wall 439; said occluding material will be removed from the permeable wall 439 after convenient heating and simultaneously to the detachment of the decorating material 449, converging on the surface 3, or successively to said detachment through the sucking means 451.

In FIG. 38 a different system for controlling the occlusion of the permeable wall 439 is shown, said permeable wall 439 now advantageously consisting of a thin metallic reticular tissue. The through openings 454a of said permeable wall 439 are completely filled, near the region 454, with a thermo-melted material 455, by means of doctor blades 455a, said thermo-melted material 455 subsequently solidifying in said openings 454a. In a subsequent station 456 said solidified material 455 is subjected to heating and consequent melting in selected regions controlled by computer means, which may take place by means of a modulated laser beam 457 as shown in the Figure o by means of other systems, known in the thermo-graphic digital printing technology.

Such melted material 455 is immediately removed by sucking means 458 acting on the opposite side and these regions 459 of the wall 439, becoming permeable, may carry a layer of decorating material 449.

In the particular case of ceramic tiles working, the surface 3 can be the surface of an already fired tile, the surface of an already formed but not fired tile, the surface of a belt used as pressing means as described in the PCT-EP95-04560, or the surface of a punch of the pressing die.

The powders 410, 449 are not necessarily monochromatic but may consist of various, unmixed colours and the device may be provided with more heads 405 with relative feeders 406.

With reference to FIGS. 39 and 40, the device 501 comprises a hopper 502 inside which a decorating powdered material 1 is contained.

The bottom of the hopper is delimited by a plate 504a which defines, together with another flat slab 505, a lateral slot 506 through which the decorating material 1 can flow.

The upper surface 504 of the plate 504a is substantially flat and ends, in the portion near the lateral slot 506, with a plurality of elements 507 vibratingly actuatable.

Said elements 507 consist of a set of bodies 508 made of piezoelectric material sealed between a base electrode 509 and a set of upper electrodes 510. Said electrodes 509, 510 are connected to control means controlled by computer C3 and memory M2 and therefore each element 507 may vibrate independently in a direction A3 perpendicular to the plane 504 of the plate 504a.

If no vibration is present, the powder 1 is arranged according to a disposition D3, making an angle B3 with a horizontal line in an end portion thereof, said angle B3 corresponding to the limit sliding angle of the powder 1 in a static condition, and therefore the powder cannot flow. (The limit static sliding angle B3 crosses the surface 504 at point Z). When the element 507 is vibrated, the sliding angle decreases until the value E3 and the powder 1 immediately flows; on the other hand, when vibration ends, the powder arranges again according the disposition D3 and the flow stops. This happens only at each single activated element 507, and a controlled feeding of powder 1 may therefore be carried out, by properly varying the sequence, the intensity and possibly even the vibrating frequency of single elements 507, said controlled feeding allowing a desired pattern to be obtained on the underlying surface 3.

The flow of powder 1 is caused both since the limit sliding angle changes (from B3 to E3) and since that the powder 1 rests on the contact surface 504, when the vibration is active, without any substantial friction and a good flow of powder may be therefore easily obtained even with minimal applied energy. The position and inclination of plate 504a and of flat slab 505 will be properly adjustable for adjusting working according to different kinds of powder and different requirements.

The device is extremely simple, effective and exact: for example the elements 507 may have an even quite small width, for obtaining a greater definition in feasible drawings, which however does not compromise the flowing freedom of the powder 1 which does not have to pass through small openings.

The flow rate of powder 1 is furthermore easily controllable by properly varying the vibration amplitude and frequency.

Anyway, the best results may be obtained by using highly loose micro-granulated powders 1.

The device simplicity and the noiselessness is also due to the fact that practically no moving parts are present, since the vibrators 507 are the only movable elements and, on the other hand, said vibrators 507 may be considered as substantially static, due to their size and the minimal oscillating vibration movement inside the material elastic field.

The energies required for obtaining the sliding of powder 1 are very small and the plate 504a may therefore consist of a single board with the elements 507, the printed electrical circuits W and the converters digital/analog integrated thereinto.

The vibrating frequency may be widely varying and may range from sonic to ultrasonic field according to the requirements.

In FIG. 42 a different version of the device according to the invention is shown.

In this case, the transferring means is shaped like a belt 513 and is movable around rollers 514. Said belt 513 is made by a reticular texture 515 (FIG. 46) which is filled with decorating material 516 when passing in a feeding station 517 consisting in this case of doctor blade means 518.

In the lower portion, near the surface 3 to be decorated, the belt 513 contacts an array of vibrating elements 519 which, when activated, cause the decorating material 516 to be projected towards the surface to be decorated 3, as shown in FIG. 46. This version of the device may even work with unslidable or adhesive decorating materials 516, such as pasty decorating materials made of powders mixed with liquid means. In FIG. 44 a different type of belt 513 is shown, whose surface, at the face opposite to the face exposed to the vibrating element 519, is provided with a plurality of small cavities 520 suitable for being filled with the decorating material 516 in the feeding station 517, and for being emptied by means of the vibrating elements 519.

In the version of FIG. 45, a layer 522 of decorating material 516 is kept adherent to the transferring belt 513 by means of vacuum P acting through a suitable permeability present in the belt 513 and said layer 522 is then selectively transferred to the surface 3 by means of the vibrating elements 519.

The decorating material 516 which is not expelled by the vibrating element 519, remains attached to the belt 513 and is integrated with other material 516 when passing near the feeding station 517.

The transferring belt 513 is not necessarily provided with synchronised speed with respect to the surface 3, but it may have higher or lower speed for transferring more or less decorating material 516 to the surface 3.

The array of vibrating elements 519 may transversely be aligned with respect to the advancing direction of the surface 3, in such case the array of elements 519 will be stationary and will cover the whole width of the surface 3. On the other hand, the array of vibrating elements 519 may be aligned in the opposite direction, i.e. parallel to the advancing direction of the surface 3, in this case said array will be provided with scanning transverse movement for reaching the whole width of the surface 3.

The space between the vibrating elements 507, 519 may be advantageously filled with suitable elastomer material for preventing powder from penetrating said space. For this purpose a film for surface coating may also be provided, said film performing also other functions, such as: anti-wear, anti-friction, anti-adherence.

With reference to FIG. 47, the apparatus consists of a traditional, vertical axis, press provided with a fixed base frame 601 and of an upper portion 602 vertically movable, so as to move close and far from said base frame 601. A die is mounted on the press, said die being provided with a lateral matrix 603, a lower punch 604 and an upper punch 605. Loading means for loading the base powders 606 is present, said loading means being of a drawer type with sliding grid 607, and being furthermore suitable for ejecting along an exit direction A4 the already formed tile 608.

In the front portion of the press, i.e. in the portion from which the tiles 688 are ejected, a decorating means is arranged, said decorating means consisting of a belt 609 closed in a loop, wound around a first roller 610 at the belt end nearest to the press, a tensioning roller 613 at the opposite end, and a pair of transmission rollers (respectively 611 and 612).

The first roller 610 is horizontally movable from a position external to the die to an end position, crossing the whole die plan.

During this excursion, the belt 609 is kept properly tensioned by the tensioning roller 613, which may be vertically moved upwards or downwards. Decorating devices 614 are facing the upper surface of the high branch of the belt 609, said decorating device 614 being suitable for applying decorating materials 615 on said belt 609.

As shown in FIG. 47, while the die is open the drawer 606 ejects the tile 608 and brings the powder 606 into the die, simultaneously the roller 610 moves in direction B4 towards the die inner portion. During this movement the rollers 610 and 613 are not rotating, the two branches of belt 609 move with equal speed C4, the roller 613 lowers keeping the belt 609 tensioned and the decorating devices 614 apply the decorating materials 615 on the surface of the belt 609.

When the roller 610 has reached the end stroke position, a second step begins (FIG. 48) in which the belt 609 is firstly brought in contact with the upper half of the die 605 by raising a proper pressing roller 616, then, while the upper branch of the belt is standing still, the roller 610 and the pressing roller 616 withdraw at a speed V3, the lower branch of the belt 9 withdraws at a speed V4, V4 being twice V3. Said lower branch of the belt 9, winding around the transmission roller 612, is kept tensioned by the tensioning roller 613 which rises and simultaneously rotates counterclockwise.

When the belt 609 contacts and the half-die 605, the decorating materials 615 are transferred to said half-die and subsequently, during the pressing step, are transferred to the tile 608.

The belt 609 may have a smooth surface, in this case the decorating devices 614 will consist of by silk-screen, pad-printing or intaglio machines, or other.

On the other hand, the belt 609 may have an engraved surface according to the desired patterns, the belt 609 being in this case the decorating matrix.

The belt 609 may also consist of a silk-screen with open regions and closed regions according to the desired drawing, in such case the open regions will be previously filled with the decorating material by sliding, through feeding means consisting for example of a pair of opposite doctor blades arranged in the area where, in FIG. 47, decorating devices 614 are arranged. In this case, and in any other case, the roller pressing means 616 may be replaced by a doctor blade.

The rolling decorating devices 614 shown in FIG. 47 may be activated only when the upper branch of the belt 609 moves, and in this case said decorating devices 614 will be kept in their position, simply rotating around their own axis. The decorating devices 614 may advantageously work during the whole cycle comprising advancing, withdrawal and stop of said upper branch, a constant translation speed being kept between said decorating devices 614 and said upper branch of the belt 609. This may enhance the working stability of said decorating devices 614, because they will work continuously and with lower speeds.

On the belt 609, proper cleaning means may be advantageously mounted, and similarly cleaning means, arranged near the roller 610, may be provided for cleaning the half-die 605.

It is noted that working is quite fast since the forwards and backwards movement of the belt 609 may be simultaneous to the forwards and backwards movement of the drawer 607; also the height dimension of the belt 609 and of the relative roller 610 may be reduced to the minimum for allowing a short and quick stroke of the half-die 605.

Also the arrangement of the belt 609 in front of the press is advantageous since it allows not to interfere with the usual die loading means.

If necessary, the decorating means may also consist of a simple translating roller in rolling contact under the half-die 605, or of any other printing means even intermittent.

In addition, said decorating means may be introduced from the back side of the press and possibly directly associated with the feeding drawer 607.

The die shown in the example has only one lateral matrix 603 but any other type of known die may be advantageously used, for example a double lateral matrix die.

The feeding system for feeding base powder 606 may be of any other kind.

The decorating materials will be of a damp or pasty type for improving their adhesion to the surface of the half-die 605; anyway decorating materials in a dry or grain powder state may also be used, suitable expedients being adopted for keeping said material adherent to the half-die 605. Said expedients may consist in using electrostatic forces, adhesive means, electromagnetic attraction means if suitable decorating materials are used, or vacuum pressure attraction means.

The decorating materials may also consist of a decalcomania.

With reference to FIG. 49, the apparatus is constituted by a base belt 701 movable around rollers 702, on the upper branch of said belt 701 a distributor for distributing powders 704 being present, said distributor forming a continuous layer 705 of said powders 704.

Downstream, along the path of the upper branch of belt 701 a reference plane 706 of a not shown press is arranged, said plane resting below said branch.

Correspondingly, on the other face of the belt 701 the movable body 707 of the press is arranged, said body being movable perpendicularly to the surface of belt 701 along the direction shown by the arrow F1, so as to move close to, or away from, said surface.

On the lower face of the moving body 707 a second belt 708 is arranged, wound on first rollers 709 and second rollers 710.

Said second rollers 710 are movable according to the arrows G1 so as to keep tensioned and in the right position the second belt 708 while the movable body 707 is moving.

On the upper branch of the second belt 708 decorating means 711, drying means 712 and distributing means 713 for powders and/or grits are arranged.

While working, when the movable body 707 is raised, the base belt 701 and the second belt 708 are indexed of a step; during this movement each decorating means 711 applies on the second belt 708 a respective decorating material 712, arranged according to a desired pattern, in overlapping manner or in sequence.

The decorating materials 714, which are advantageously applied as suspension in a liquid means, remain attached to the surface of the second belt 708 and are dried when passing under the drying means 712.

Said decorating materials are indexed towards the pressing station and here joined to the underlying layer 705.

Also the body of pressed tile 608 indexes towards the outlet and is cut at the desired size by suitable means 716.

This type of forming is particularly suitable for producing tiles of big size, which theoretically may have no limits in length.

Therefore a tile size as largest as possible may be advantageous sent to oven, said tile being subsequently cut to the required measure. Such process offers the advantage that tiles are obtained, whose dimension is not affected by possible differences in shrinkage during firing.

Anyway, the tile 608 may be cut in the final size by the proper means 716, or may be furthermore pressed until it reaches the desired measure in a further pressing station (not shown) according to known means. This last version may be advantageous since it allows a lighter pressing to be carried out in the first pressing station and a better defined tile as regards tile shape to be obtained, as for example: the tile may be better shaped at its border with possible spacers, the edge on the visible face may be provided with a rounded border, or again the tile rear face may be printed with a “mark” of drawing centred with respect to the border.

On the second belt 708 the decorating materials may be applied according to all the known techniques, such as: silk-screen rotating machines, or silk-screen reciprocating machines provided with flat screen, intaglio machines provided with laser engraved cavities, pad printing roller or reciprocating machines, machines working without contact, electrostatic transfer machines etc.

The most various known decorating materials, whose use is known on ceramic products, may be applied.

A decorating means 711 may be used for applying, according to a desired pattern, a suitable, temporary adhesive material on which, in a subsequent station 712, a decorating powdered or granular material is applied, said decorating material being attached to the belt 708 only where said adhesive material is applied. This technique is particularly suitable since it allows a quite thick decoration to be obtained (also with coarse grains), with a good drawing definition (the definition of the decorating means 711 damp working in direct contact with a smooth surface) and with the whole thickness of decoration 714 perfectly incorporated into the tile 608.

The decorations applied with the second belt 708 may also be completed with other decorations applied on the layer 705 by decorating means 718, and in addition, if the second pressing is carried out, further decorating materials may be applied between the first pressing station and the second pressing station.

The FIG. 50 shows a sketched apparatus in which the upper matrix for pressing and decoration transferring consists of a roller 719, continuously rotating about on horizontal axis, instead of being constituted by a belt 708 as in FIG. 49.

With reference to FIG. 49, the invention may also be carried out providing the base belt 701 and the second bet 708 of a continuous motion, in such case the body 707 will be stationary and suitable rolling means will be interposed between the belts 701 and 708 and the respective contrast bodies 706 and 707, said rolling means being suitable for transmitting the pressing forces with the belts 701 and 708 in movement.

Again, with reference to FIG. 49, in the version provided with a step movement, the position and the function of the two bodies 706 and 707 may be reversed, i.e. the upper body will be kept stationary, thus behaving like a contrast body, while the lower body will be moved in direction perpendicular to the belt 701.

Furthermore, when working by steps, the decorating means 711, 713 may continuously act on the belt 708 when said belt is moving, or may reciprocatingly act on the belt 708 when it is stationary.

The belts 701, 708 will consist of suitable pressure-resistant material whose active surface may be treated so as to be kept clean, for this purpose cleaning means 720 may be installed.

Particularly referring to the second belt 708 and the roller 719, they may be made of steel possibly with chromium-plated surface and they will be advantageously kept at a suitable temperature, at least in the region corresponding to pressing; this will allow the decorating materials 714 to be mote easily dried and detached and a better surface of the tile 608 to be carried out.

The belt 708 and the roller 719 may be also provided with cavities and protrusions suitable for defining a structured surface of the tile 608; said protrusions may furthermore define preferred fracture lines for obtaining the tiles 608 without using cutting means 716. Also the base belt 701 may be provided with surface suitable for defining on the rear face of tile 608 some support appendices for supporting said tile and/or preferred fracture lines.

The invention may be carried out also with a traditional pressing of intermittent type, for example as shown in FIG. 51, with a pressing die 721 of the type provided with vertically movable lateral frame 722, upper punch 727 and lower punch 730; in this case the base powders 723 are loaded in the opening of the die 721 with the conventional known means (for example movable drawer means provided with grid 725) and the belt 708 is indexed between the lateral frame 722 and the upper punch 724.

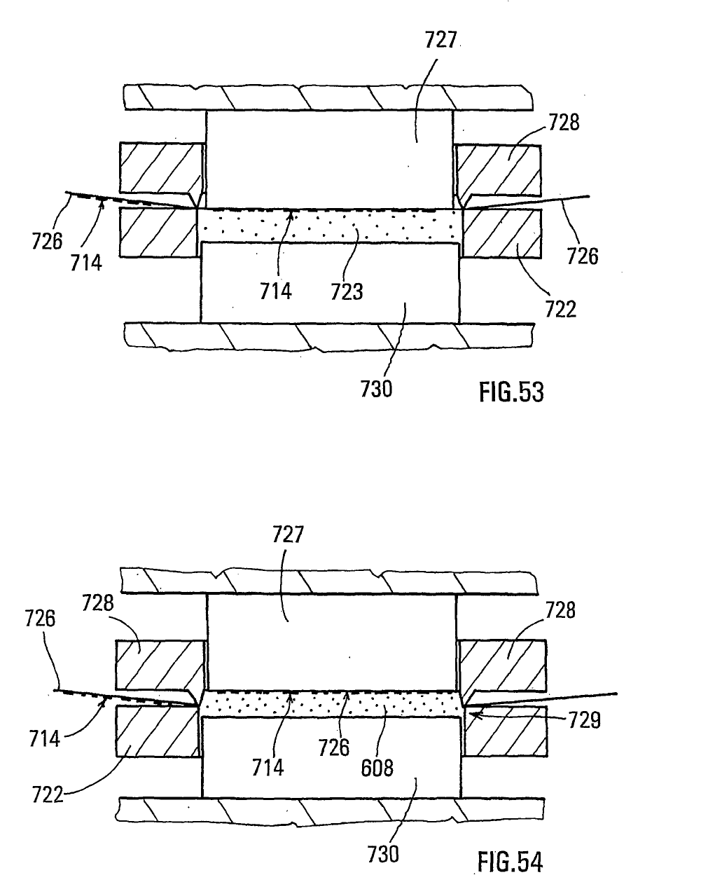

In the version of FIG. 52 the belt is constituted by a thin disposable belt 726 a portion of which, corresponding to the tile size, is sheared in the pressing step by a cutting edge present in the upper frame 728 (FIG. 53).

On the other hand, said shearing may be obtained through simultaneous action of the upper punch 727 and the lower frame 722.

As shown in FIG. 54, which shows the pressing end step, the tile 608 is partially pressed inside an upper frame 728 and it may therefore be shaped with a spacer 729 arranged in the lower portion thereof.

As shown in FIG. 55, the belt 708 is provided with protrusions 731, arranged transversely and longitudinally, so as to form a frame with oblique internal walls, said protrusions 731 are advantageously made by elastomer permeable material for allowing air to easily escape. The tile 732 is so pressed with exceeding material all around, said exceeding material being then removed by the cutting means 716. In the shown example, the active portion of pressing is the lower one, therefore the upper body 733 constitutes the contrast plane and the lower body 734 is movable in direction F1.

Since decorating materials 714 are applied on the belt 708 only inside the frame 731, the decorating means may be provided with movement in direction F2 for avoiding interference with said frame 731. Furthermore, said decorating means 711 will be advantageously spaced by a distance equal to the belt advancing step so as to be at the external regions of the frame 731, during the pressing step; thus the pressing time may be advantageously used for drying actions or other on the applied decoration 714.

The described examples refer to ceramic tiles production, but the invention may be applied also in other fields, such as: concrete tiles production, production of plates in plastic material, production of plates in various materials etc.

1. Method for applying powdered material (1) on a surface (3), characterised in that, it is provided:
forming a flow of liquid (8);
associating portions of said powdered material (1) with said flow of liquid (8);
moving said flow of liquid (8), together with said portions, towards said surface (3).

2. Method according to claim 1, characterised in that, said forming comprises ejecting said liquid in form of drops (8).

3. Method according to one or more of the preceding claims, characterised in that, said forming comprises ejecting said liquid (8) from ejectors (7) arranged in array and controlled by computer means.

4. Method according to one or more of the preceding claims, characterised in that, said flow of liquid (8) is directed towards said surface (3).

5. Method according to one or more of the preceding claims, characterised in that, said associating comprises causing said flow of liquid (8) to interfere with a flow (2) of said powders (1).

6. Method according to claim 5, characterised in that, said flow (2) of said powders (1) extends in a transverse approaching direction with respect to said flow of liquid (8).

7. Method according to one or more of the preceding claims, characterised in that, it further comprises removing from said portions of said associated powdered material (1) the excess of non-associated powdered material (1).

8. Method according to claim 7, characterised in that said removing occurs during said moving towards said surface (3).

9. Method according to claim 7, characterised in that, said removing occurs after said portions of said associated powdered material (1) and said excess of non-associated of powdered material (1) have reached said surface (3).

10. Method according to claim 7, characterised in that, said removing occurs on the side opposite to the side where said transverse approaching occurs, with reference to the plane where said flow of liquid (8) extends.

11. Method according to claim 7, characterised in that, said removing occurs from the same side where said transverse approaching occurs, with reference to the plane where said flow of liquid (8) extends.

12. Method according to claim 11, characterised in that, said removing and transverse approaching occur by means of the same transport means (16).

13. Method according to one or more of the preceding claims, characterised in that, said associating comprises using electrostatic forces.

14. Method according to one or more of claims 7 to 13, characterised in that, said removing comprises using electrostatic forces.

15. Method according to one or more of the preceding claims, characterised in that, it comprises using said surface (3) as a transferring surface for applying said powders (1) on another surface.

16. Method according to one or more of the preceding claims, characterised in that, it is used for decorating ceramic tiles.

17. Device for applying powdered material (1) on a surface (3), characterised in that, it comprises ejector means (7) for ejecting liquid (8) and conveying means (11, 12, 13, 15, 16, 18, 19) suitable for associating portions (9) of said powders (1) to said ejected liquid (8).

18. Device according to claim 17, characterised in that, said ejector means (7) is arranged aligned in array.

19. Device according to one or more of claims 17 or 18, characterised in that, said ejector means (7) is controlled by computer means.

20. Device according to one or more of claims 17 to 19, characterised in that, said ejector means (7) is suitable for ejecting said liquid in form of drops (8).

21. Device according to one or more of claims 17 to 20, characterised in that, said ejector means (7) is oriented towards said surface (3).

22. Device according to one or more of claims 17 to 21, characterised in that, it further comprises carrying means (4, 5, 6, 14, 16, 20) suitable for recovering the excess of said non-associated powdered material (1).

23. Device according to one or more of claims 17 to 22, characterised in that, said conveying means (11, 12, 13, 15, 16, 18, 19) comprises means (11, 12, 15, 16, 17) suitable for exerting electrostatic forces.

24. Device according to one or more of claims 17 to 23, characterised in that, said conveying means (11, 12, 13, 15, 16, 18, 19) comprises first belt means (16, 19).

25. Device according to one or more of claims 17 to 24, characterised in that, said conveying means (11, 12, 13, 15, 16, 18, 19) comprises blowing means (18).

26. Device according to one or more of claims 17 to 25, characterised in that, said conveying means (11, 12, 13, 15, 16, 18, 19) comprises conduits (13) suitable for carrying said powders (1) in gaseous suspension.

27. Device according to one or more of claims 22 to 26, characterised in that, said carrying means (4, 5, 6, 14, 16, 20) comprises slide deflecting means (4).

28. Device according to one or more of claims 22 to 27, characterised in that, said carrying means (4, 5, 6, 14, 16, 20) comprises second belt means (5, 6, 16, 20).

29. Device according to claim 28, characterised in that, said belt means (5, 6) is movable in a transverse direction with respect to the direction (A) of movement of said surface (3).

30. Device according to claim 28, characterised in that, said belt means (16, 20) is movable, at least in a portion, in a parallel direction with respect to the direction (A) of movement of said surface (3).

31. Device according to one or more of claims 22 to 30, characterised in that, said carrying means (4, 5, 6, 14, 16, 20) comprises suction conduits (14).

32. Device according to one or more of claims 22 to 31, characterised in that, said carrying means (4, 5, 6, 14, 16, 20) is cooperating with electrostatic means (16, 20) suitable for exerting attraction on said powders (1).

33. Device according to one or more of claims 22 to 32, characterised in that, said carrying means (4, 5, 6, 14, 16, 20) is arranged at the opposite side with respect to the side where said conveying means (11, 12, 13, 15, 16, 18, 19) is arranged, with reference to the plane in which said ejected liquid (8) extends.

34. Device according to one or more of claims 22 to 32, characterised in that, said carrying means (4, 5, 6, 14, 16, 20) and said conveying means (11, 12, 13, 15, 16, 18, 19) are arranged on the same side, with reference to the plane where said ejected liquid (8) extends.

35. Device according to claim 34, characterised in that, said carrying means (4, 5, 6, 14, 16, 20) and said conveying means (11, 12, 13, 15, 16, 18, 19) constitute a single integrated means (16).

36. Device according to claim 35, characterised in that, said integrated means (16) is a belt (16) wound in a closed loop.

37. Device according to claim 36, characterised in that, said integrated means (16) is a roller.

38. Device according to any of claims 17 to 37, characterised in that, it is used for decorating ceramic tiles.

39. Device according to any of claims 17 to 38, characterised in that, said powders (1) are pseudo-spherical agglomerates obtained by atomisation.

40. Method for three-dimensionally arranging decorating materials (1, 103, 104, 105, 106, 516) in a body (104a) having a decorated surface (M), characterised in that, it provides the following steps:
forming a stratification (101a, 101b), continuous (101b) or discontinuous (101a), with said decorating materials (1, 103, 104, 105, 106, 516) according to a pattern extending in the plane of said stratification (101a, 101b);
transferring said stratification (101a, 101b) to said body (104a) in such a way as to reduce the dimensions of said pattern along a direction (V1) parallel to said decorated surface (M).

41. Method according to claim 40, wherein said forming comprises distributing said decorating materials (1, 103, 104, 105, 106, 516) on a transferring surface (3, 101, 512).

42. Method according to one or more of claims 40 or 41, wherein said transferring comprises overlapping portions of said stratification (101a, 101b) along a direction (V1) parallel to said decorated surface (M).

43. Method according to one or more of claims 40 to 42, wherein said stratification (101a, 101b) is made of a plurality of decorating materials (1, 103, 104, 105, 106, 516).

44. Method according to claim 43, wherein said plurality of decorating materials (1, 103, 104, 105, 106, 516) is arranged in various overlapping layers.

45. Method according to claim 43, wherein said plurality of decorating materials (1, 103, 104, 105, 106, 516) is sequentially arranged on the same layer.

46. Method according to one or more of claims 40 to 45, wherein said stratification (101a, 101b) is of substantially uniform thickness.

47. Method according to one or more of claims 41 to 46, wherein during said transferring it is provided:
removing said stratification (101a, 101b) from said transferring surface (101), in a station;
moving at a transferring speed (V2) said transferring surface (101) towards said station and
displacing said body (104a) with respect to said station with speed (V1) lower than said transferring speed (V2).

48. Method according to claim 47, wherein said moving occurs at a speed (V2) equal to or 1.5 times greater than the speed (V1) of said moving.

49. Method according to claim 47, wherein said moving occurs at a speed (V2) equal to or 3 times greater than the speed (V1) of said moving.

50. Method according to claim 47, wherein said moving occurs at a speed (V2) equal to or 5 times greater than the speed (V1) of said moving.

51. Method according to claim 47, wherein said moving occurs at a speed (V2) equal to or 10 times greater than the speed (V1) of said moving.

52. Method according to one or more of claims 40 to 51, wherein after said transferring, a layer of decorating materials (1, 103, 104, 105, 106, 516) is obtained in said body (104a), said layer having a thickness (L, N) greater than the thickness of said stratification (101a, 101b).

53. Method according to one or more of claims 40 to 52, wherein after said transferring, a thick layer (Q) of decorating materials (1, 103, 104, 105, 106, 516) is obtained in said body (104a), said decorating materials (1, 103, 104, 105, 106, 516) being arranged substantially in the same configuration in each plane parallel to said decorated surface (M).

54. Method according to claim 53, wherein said thick layer (Q) extends in the whole thickness of said body (104a).

55. Method according to one or more of claims 43 to 53, wherein each of said decorating materials (1, 103, 104, 105, 106, 516) is distributed in distinct distributing stations (F, G, H, I).

56. Method according to one or more of claims 40 to 55, wherein said transferring comprises causing said stratification (101a, 101b) to slide on the surface of a deflector (108).

57. Method according to one or more of claims 40 to 56, wherein said transferring comprises causing said stratification (101a, 101b) to slide on the downwards oriented surface of a deflector (108).

58. Method according to one or more of claims 40 to 57, wherein said transferring comprises folding said stratification (101a, 101b) in a zigzag configuration (R).

59. Method according to the preceding claim wherein said folding is obtained by reciprocating said deflector (108).

60. Method according to one or more of claims 40 to 59, wherein said transferring comprises causing said stratification (101a, 101b) to slide on an inclined surface (115) of said decorating materials (1, 103, 104, 105, 106, 516), said inclined surface (115) being the free surface defined by the sliding angle of the decorating powdered materials (1, 103, 104, 105, 106, 516) under the action of the force of gravity.

61. Method according to one or more of claims 40 to 60, wherein during said transferring it is provided forming a thick layer (L, R) of decorating materials (1, 103, 104, 105, 106, 516), said thick layer (L, R) having venations crossing the whole thick layer (L, R) and it is provided rotating said thick layer (L, R) so that the thick layer (L, R) is substantially arranged in a horizontal plane.

62. Method according to one or more of claims 40 to 61, wherein said transferring comprising moving said decorating materials (1, 103, 104, 105, 106, 516) into a space (109).

63. Method according to one or more of claims 40 to 62, wherein said transferring comprises moving said decorating materials (1, 103, 104, 105, 106, 516) into a plurality of spaces (119a) transversely extending with respect to said advancing direction (V2).

64. Method according to one or more of claims 40 to 63, wherein said forming comprises distributing decorating materials (1, 103, 104, 105, 106, 516) with devices (250, 501) controlled by computer means (M2, C3, C1, P1).

65. Method according to one or more of claims 40 to 64, wherein said forming comprises distributing decorating materials (1, 103, 104, 105, 106, 516) with devices comprising a plurality of vibrating means (507, 519) arranged in array.

66. Method according to one or more of claims 40 to 65, wherein said forming comprises distributing decorating materials (1, 103, 104, 105, 106, 516) with devices comprising means (210, 230, 233) suitable for selectively deflecting a flow (205) of said decorating materials (1, 103, 104, 105, 106, 516) by means of electrostatic forces.

67. Method according to one or more of claims 40 to 66, wherein said forming comprises distributing decorating materials (1, 103, 104, 105, 106, 516) with devices comprising a plurality of means (231, 242) arranged in array and suitable for selectively deflecting a flow (205) of said decorating materials (1, 103, 104, 105, 106, 516).

68. Method according to one or more of claims 40 to 67, wherein said forming comprises distributing decorating materials (1, 103, 104, 105, 106, 516) with devices comprising ejectors for ejecting liquid state dyes, said ejectors being arranged in array.

69. Method according to one or more of claims 40 to 68, wherein after said forming it is provided compacting said stratification (101a, 101b).

70. Method according to one or more of claims 40 to 69, wherein, since said body (104a) is temporarily in a powdery state and is supported on a support surface (112), said body (104a) is then directly pressed on said support surface (112) together with said decorating materials (1, 103, 104, 105, 106, 516).

71. Method according to claim 70, wherein said pressing is carried out continuously.

72. Method according to one or more of claims 40 to 71, wherein said body (104a) is a ceramic tile (608).

73. Method according to one or more of claims 40 to 72, wherein said decorating materials (1, 103, 104, 105, 106, 516) are ceramic raw materials.

74. Method according to one or more of claims 40 to 73, wherein said decorating materials (1, 103, 104, 105, 106, 516) are in a powdery state.

75. Device for three-dimensionally arranging decorating materials (1, 103, 104, 105, 106, 516) in a body (104a), according to a pre-established pattern, characterised in that, it comprises:
a transferring surface (3, 101, 512) suitable for receiving a continuous or discontinuous stratification (101a, 101b) of said decorating materials (1, 103, 104, 105, 106, 516);
first means (250, 501) suitable for arranging said decorating materials (1, 103, 104, 105, 106, 516) on said transferring surface (3, 101, 512), according to a pattern corresponding to said pre-established pattern stretched and enlarged in a transferring direction (V2) parallel to said transferring surface (3, 101, 512);
second means (108, 110, 111, 117, 119) suitable for transferring said decorating materials (1, 103, 104, 105, 106, 516) from said transferring surface (3, 101, 512) to said body (104a) so that said decorating materials (1, 103, 104, 105, 106, 516) are arranged according to said pre-established pattern on said body (104a).

76. Device according to claim 75, wherein said transferring surface (3; 101, 512) is the surface of the upper branch of belt (101) closed in a loop.

77. Device according to any of claims 75 or 76, wherein said second means (108, 110, 111, 117, 119) comprises a deflecting wall (108, 111) having a curved surface.

78. Device according to claim 77, wherein said deflecting wall (108, 111) is reciprocable.

79. Device according to one or more of claims 75 to 78, wherein said second means (108, 110, 111, 117, 119) comprises rotating surfaces (110, 117, 118, 119) for containing said decorating materials (1, 103, 104, 105, 106, 516).

80. Device according to one or more of claims 75 to 79, wherein said second means (108, 110, 111, 117, 119) comprises a plurality of openings (119a), having a quite small size along said transferring direction (V1) and a quite long size in the direction transverse to said transferring direction (V1), said plurality of openings (119a) being arranged along said transferring direction (V1) and being movable along said transferring direction (V1).

81. Device according to one or more of claims 75 to 80, wherein said first means (250, 501) distributes decorating materials (1, 103, 104, 105, 106, 516) and are controlled by computer means (M2, C3, C1, P1).

82. Device according to one or more of claims 75 to 81, wherein said first means (250, 501) distributes decorating materials (1, 103, 104, 105, 106, 516) and are point by point controlled by computer means (M2, C3, C1, P1).

83. Device according to one or more of claims 75 to 82, wherein said first means (250, 501) comprises a plurality vibrating means (507, 519, 242) arranged in array.

84. Device according to claim 83, wherein said vibrating means (507, 519, 242) is piezoelectric vibrating means.

85. Device according to one or more of claims 75 to 84, wherein said first means (250, 501) comprises means (210, 230, 233) suitable for selectively deflecting a flow (205) of said decorating materials (1, 103, 104, 105, 106, 516) by means of electrostatic forces.

86. Device according to one or more of claims 75 to 85, wherein said first means (250, 501) comprises a plurality of means (231, 242) arranged in array and suitable for selectively deflecting a flow (205) of said decorating materials (1, 103, 104, 105, 106, 516).

87. Device according to one or more of claims 75 to 86, wherein said first means (250, 501) comprises ejecting devices for ejecting liquid state dyes, said ejecting devices being arranged in array.

88. Device according to one or more of claims 75 to 87, wherein said first distributing means (250, 501) is sequentially arranged in various stations (F, G, H, I).

89. Device according to one or more of claims 75 to 88, wherein between said first means (250, 501) and said second means (108, 110, 111, 117, 119) pressing means is present suitable for compacting said decorating materials (1, 103, 104, 105, 106, 516).

90. Device according to one or more of claims 75 to 89, wherein, since said body (104a) is temporarily in a powdery state and it is supported on a support surface (112), pressing means is present comprising said support surface (112).

91. Device according to claim 90, wherein said pressing means is continuously or step-by-step actuated.

92. Device according to one or more of claims 75 to 91, characterised in that, it is used for producing ceramic tiles.

93. Device according to one or more of claims 75 to 92, wherein said decorating materials (1, 103, 104, 105, 106, 516) are in a powdery state.

94. Method for applying powdered material (1) on a surface (3) according to a pre-established pattern, characterised in that, the following steps are provided:
generating a flow (205) of said powder (1);
selectively deflecting said flow (205), so as to cause said flow (205) to be applied on said surface (3) or not to be applied on said surface (3).

95. Method according to claim 94, wherein said deflecting is directly controlled by computer means (C1, P1).

96. Method according to one or more of claims 94 or 95, wherein said deflecting comprises selectively operating on said powder (1) of said flow (205) with vibrating means (241, 242, 243, 244, 245).

97. Method according to one or more of claims 94 to 96, wherein said deflecting comprises electrically and selectively charging said powder (1) of said flow (205) and causing said flow (205) to cross an electric field (216).

98. Method according to one or more of claims 94 to 97, wherein said deflecting comprises electrically charging said powder (1) of said flow (205) and causing said flow (205) to cross a modulated electric field (229).

99. Method according to one or more of claims 94 to 98, wherein said flowing is due to force of gravity.

100. Method according to one or more of claims 94 to 99, wherein said surface (3) is moving in a moving direction.

101. Method according to claim 100, wherein said moving direction is horizontal.

102. Method according to one or more of claims 94 to 101, wherein said flowing occurs a continuous thin layer (205) whose width is at least equivalent to the width of the surface (3) on which said powder (1) is arranged.

103. Method according to claim 102, wherein said thin layer (205) is transverse with respect to said moving direction of said surface (3).

104. Method according to one or more of claims 94 to 103, wherein said powder (1) of said flow (205) which is not designed for being arranged on said surface (3) is deflected by conveying means (218).

105. Method according to one or more of claims 94 to 104, wherein said powder (1) of said flow (205) which is not designed for being arranged on said surface (3) is moved away on belt means (219) provided with movement in a transverse direction with respect to said moving direction of said surface (3).

106. Method according to one or more of claims 94 to 105, and further comprising, before said deflecting, an alignment step for aligning said flow (205) by causing said flow (205) to move between a pair of elements (209, 228) electrostatically charged with the same polarity with which said powder (1) of said flow (205) is charged.

107. Method according to any of claims 97 to 106, wherein said electrostatically charging comprises using emitting sources of ions (208, 211, 226).

108. Method according to any of claims 97 to 106, wherein said electrostatically charging comprises using electrodes in direct contact with said powder (1).

109. Method according to any of claims 97 to 108, wherein said selectively and electrostatically charging comprises using modulated laser beam means (213, 216).

110. Method according to one or more of claims 94 to 109, wherein said deflecting comprises using an electric field (229) variable in time from region to region transversely with respect to said direction of flow.

111. Method according to one or more of claims 94 to 110, wherein said deflecting comprises using an electric field (229) variable in time from region to region longitudinally with respect to said direction of flow.

112. Method according to one or more of claims 94 to 111, wherein said deflecting comprises using selectively electrostatically charged movable surface (233).

113. Method according to one or more of claims 94 to 112, wherein said deflecting comprises selectively operating on said powder (1) of said flow (205) with gas ejecting means.

114. Method according to one or more of claims 94 to 113, wherein said deflecting comprises selectively operating on said powder (1) of said flow (205) with a plurality of slide means arranged in a series transversely to said flow (205) and with controlled variable inclination.

115. Method according to one or more of claims 94 to 114, wherein said flow (205) of powders (1), before being applied on said surface (3), is conveyed on canalising means (221) suitable for reducing the impact speed against said surface (3) and for imparting a movement in the same direction as the movement of said surface (3).

116. Method according to one or more of claims 94 to 115, characterised in that, it is used for applying decorating materials (1) on ceramic tiles (3).

117. Device suitable for applying powdered material (1) on a surface (3) according to a pre-established pattern, characterised in that, it comprises:
feeding means (201, 202, 204) suitable for forming a flow (205) of said powder (1);
deflecting means (210, 211, 212, 229, 230, 231, 233, 241, 242) suitable for selectively deflecting said flow (205).

118. Device according to claim 117, wherein said deflecting means (210, 211, 212, 229, 230, 231, 233, 241, 242) is controlled by computer means (C1, P1).

119. Device according to one or more of claims 117 or 118, wherein said deflecting means (210, 211, 212, 229, 230, 231, 233, 241, 242) comprises vibrating means (241, 242, 243, 244, 245) selectively controlled operating.

120. Device according to claim 119, wherein said vibrating means (241, 242, 243, 244, 245) is of piezoelectric type.

121. Device according to one or more of claims 117 to 120, wherein said deflecting means (210, 211, 212, 229, 230, 231, 233, 241, 242) comprises means (210, 211, 212) suitable for electrostatically and selectively charging said powder (1) of said flow (205), and an electric field (216) through which said powder (1) passes, said electric field (216) being selectively electrostatically charged.

122. Device according to one or more of claims 117 to 121, wherein said deflecting means (210, 211, 212, 229, 230, 231, 233, 241, 242) comprises means (225, 226) suitable for electrostatically charging said powder (1) of said flow (205), and means (230, 231) suitable for forming a modulated electric field (229).

123. Device according to one or more of claims 117 to 122, further comprising conveying means (218) suitable for capturing a selected portion of said flow (205) and moving it away from said surface (3).

124. Device according to one or more of claims 117 to 123, further comprising belt means (219) transversely arranged with respect to the advancing direction of said surface (3), said belt means (219) being suitable for conveying a selected portion of said flow (205) for removing said selected portion from said surface (3).

125. Device according to one or more of claims 117 to 124, further comprising aligning means (207, 209, 227, 228) for aligning said flow (205), said aligning means (207, 209, 227, 228) being constituted by a pair of plates (209, 228) arranged at the sides of said flow (205) and electrostatically charged with the same polarity with which said powder (1) of said flow (205) is charged.

126. Device according to one or more of claims 121 to 125, wherein said means (206, 208, 210, 211, 212, 225, 226) suitable for electrostatically charging said flow (205) of powders (1) comprises emitting sources (208, 211, 226) of ions.

127. Device according to one or more of claims 121 to 126, wherein said means (206, 208, 210, 211, 212, 225, 226) suitable for electrostatically charging said flow (205) of powders (1) comprises electrodes designed for direct contacting said powders (1).

128. Device according to one or more of claims 121 to 127, wherein said means (210, 211, 212) suitable for selectively and electrostatically charging said flow (205) of powders (1) comprises modulated beam laser means (213, 216).

129. Device according to one or more of claims 121 to 128, wherein said deflecting means (210, 211, 212, 229, 230, 231, 233, 241, 242) comprises a modulated electric field (229) generated by a set of electrodes (231) transversely arranged with respect to the direction of said flow (205).

130. Device according to one or more of claims 117 to 129, wherein said deflecting means (210, 211, 212, 229, 230, 231, 233, 241, 242) comprises a modulated electric field (229) generated by a set of electrodes (331) longitudinally arranged with respect to the direction of said flow (205).

131. Device according to one or more of claims 117 to 130, wherein said deflecting means (210, 211, 212, 229, 230, 231, 233, 241, 242) comprises means provided with movable and selectively electrostatically charged surface (33).

132. Device according to one or more of claims 117 to 131, wherein said deflecting means (210, 211, 212, 229, 230, 231, 233, 241, 242) comprises gas ejecting means with variable automatically controlled ejection.

133. Device according to one or more of claims 117 to 132, wherein said deflecting means (210, 211, 212, 229, 230, 231, 233, 241, 242) comprises slide means with variable automatically controlled inclination.

134. Device according to one or more of claims 117 to 133, further comprising a canalising means (221) cooperating with the flow (205) of powders (1) designed to be applied on said surface (3) and suitable for reducing the impact speed of said powders (1) against said surface (3) and for imparting to said powders (1) a speed having the same direction as the movement of said surface (3).

135. Device according to one or more of claims 119 to 134, wherein the space existing between said vibrating elements (242, 243, 245) is sealed with an elastic means.

136. Device according to claim 135, wherein said elastic means is arranged only externally with respect to said space, as a film extended also on the upper surface of said vibrating elements (242).

137. Device according to one or more of claims 119 to 136, wherein the surface of said vibrating elements (242) is coated with anti-abrasive material.

138. Device according to one or more of claims 117 to 137, wherein said deflecting means (210, 211, 212, 229, 230, 231, 233, 241, 242) is integrated in a board, together with the connecting electric circuits (248) and the digital/analog converters (C1).

139. Device according to claims 117 to 138, characterised in that, said powders (1) are decorating materials and/or mixtures for ceramic use and said surface (3) is the surface of a ceramic tile in a production step.

140. Method for decorating tiles (3), particularly ceramic tiles, characterised in that, the following steps are provided:
applying through applying means (304) a first material (302, 316) on selected regions (303, 317) of the surface (3) of the tile, the extension of said selected regions (303, 317) being controlled by computer means (M2, P2);
distributing on said surface (3) a second material (1, 306, 312) suitable for decoration, said second material (1, 306, 312) being distributed so as to adhere to said selected regions (303) only or to regions complementary to said selected regions (317) only.

141. Method according to claim 140, wherein said applying occurs without contact between said applying means (304) and said surface (3).

142. Method according to claims 140 or 141, wherein said first material (302, 316) is in a liquid state.

143. Method according to one or more of claims 140 to 142, wherein said first material is an adhesive material (302).

144. Method according to one or more of claims 140 to 143, wherein said first material is a repellent material (316).

145. Method according to one or more of claims 140 to 144, wherein said applying occurs by using ejecting means (304) arranged in series.

146. Method according to one or more of claims 142 to 145, wherein said first material in a liquid state (302, 316) solidifies by cooling in contact with said surface (3).

147. Method according to one or more of claims 142 to 146, wherein said distributing occurs by means of distributing devices (305, 309, 314) arranged in a distribution station (B2).

148. Method according to the preceding claim, wherein said distributing occurs without contact between said distributing devices (305) and said surface (3).

149. Method according to claims 147 and 148, wherein said distributing occurs on said selected regions (303, 317) and on said complementary regions of said selected regions (303, 317).

150. Method according to claim 149, wherein said second material (306) is removed from said surface (3) in the regions where said second material (306) is not adherent to said surface (3), in a subsequent separating station (C2).

151. Method according to one or more of claims 147 to 150, wherein said distributing occurs with contact between said distributing devices (309, 314) and said surface (3).

152. Method according to one or more of claims 147, 148, 149, 151 wherein said second material (1, 312) is removed from said surface (3), in the regions where said second material (1, 312) is not adherent to said surface (3), in the same distributing station (32).

153. Method according to one or more of claims 140 to 152, wherein said second material (1, 306) is used in a powdery state.

154. Method according to any of claims 140 to 152, wherein said second material (312) is used in a state of liquid or pasty suspension.

155. Device for decorating tiles, in particular ceramic tiles, characterized in that, it comprises:
first means (304) suitable for applying a first material (302, 316) to selected regions (303, 317) of the surface (1) of the tile;
computer means (M2, P2) controlling the extension of said selected regions (303, 317);
second means (305, 309, 314) suitable for distributing on said surface (1) a decorating material (1, 306, 312) so as said decorating material (1, 306, 312) adheres only to said selected regions (303) or only to regions complementary to said selected regions (317).

156. Device according to claim 155, wherein said first means (304) is spaced from said surface (3).

157. Device according to one or more of claims 155 and 156, wherein said first means (304) is suitable for applying materials in a liquid state (302, 316).

158. Device according to any of claims 155 to 157, wherein said first means (304) is ejecting means arranged in series and controlled by computer (M2, P2).

159. Device according to one or more of claims 155 to 158, wherein said first means (304) is associated with heating means.

160. Device according to one or more of claims 155 to 159, wherein said second means (305, 309) is applying means for applying powdered decorating material (306, 308).

161. Device according to one or more of claims 155 to 159, wherein said second means (314) is applying means for applying-decorating material in a state of liquid suspension (312).

162. Device according to one or more of claims 155 to 161, wherein said second means (309, 314) operates in contact with said surface (3).

163. Device according to one or more of claims 155 to 161, wherein said second means (305) operates spaced from said surface (3).

164. Device according to one or more of claims 155 to 163, wherein said second means (309, 314) comprises rolling devices (309, 314).

165. Device according to the preceding claim, wherein said rolling devices (309, 314) comprises a permeable wall through which a vacuum operates for causing said decorating material (1, 312) to adhere to said permeable wall.

166. Device according to one or more of claims 155 to 165, wherein suction and/or blowing means is further comprised (307), said suction and/or blowing means being arranged downstream in a separating station (C2), and being suitable for removing from said surface (3) said decorating material (306) not adhering to said surface (3).

167. Device according to claims 155 to 166, wherein said computer means (M2, P2) controls the extension of said selected regions (303, 317) point by point.

168. Method for applying loose material on a surface (3), characterised in that, the following steps are provided:
arranging a transferring means (401, 415, 421, 439) in a treatment station (T2) and associating a first material (403, 404, 422, 432, 437, 455) to selected regions of said transferring means (401, 415, 421, 439), the extension of said selected regions being controlled by computer means (12, P2);
applying said loose material (407, 410, 420, 449) to said transferring means (401, 415, 421, 439);
moving said transferring means (401, 415, 421, 439) close to said surface (3) so as to transfer to said surface (3) said loose material (1, 410, 420, 449) only on regions corresponding to said selected regions, or only on regions corresponding to complementary regions of said selected regions;
moving said transferring means (401, 415, 421, 439) back to said treatment station (T2) for cycle repeating.

169. Method according to claim 168, wherein said loose material (1, 410, 420, 449) is a decorating material (407, 410, 420, 449) and said surface (3) is a surface to be decorated (3).

170. Method according to any of claims 168 or 169, which is applied to ceramic tiles production.

171. Method according to one or more of claims 168 to 170, wherein said associating comprises arranging adhesive materials (403, 404).

172. Method according to one or more of claims 168 to 170, wherein said associating comprises arranging anti-adhesive materials (422, 437, 455).

173. Method according to one or more of claims 168 to 172, wherein said associating comprises arranging said first material (422, 432, 437, 455) in selected regions of said transferring means (439) so as to close through openings (454a) provided in said transferring means (439); and said moving close comprises causing said loose material (449) to adhere to said transferring means (439) in complementary regions to said selected region, by means of a vacuum operating through said through openings (454a).

174. Method according to claim 173, wherein said arranging comprises using electrostatic attraction.

175. Method according to claim 174, wherein said arranging comprises scanning the surface of a body (434) with modulated laser beam (435).

176. Method according to claim 173, wherein said arranging comprises projecting said first material (422) in a melted state on said transferring means (439) on which then said first material (422) solidifies.

177. Method according to one or more of claims 168 to 176 wherein said associating comprises closing the through openings (454a) of said transferring means (439) with a thermo-meltable material (455) in a melted state; causing said thermo-meltable material (455) to solidify by cooling; melting or sublimating said thermo-meltable material (455) at selected regions of said transferring means (439); removing said thermo-meltable material (455) melted or sublimated from the through openings (454a) of said selected regions; and said moving close comprises causing said loose material (449) to adhere to said selected regions by means of a vacuum operating through said through openings (454a).

178. Method according to claim 177, wherein said melting or sublimating is carried out by heating through a dot matrix.

179. Method according to claim 177, wherein said melting or sublimating is carried out by heating through modulated laser beam (457) scanning.

180. Method according to one or more of claims 168 a 179, wherein said associating comprises arranging on said transferring means (401, 415, 421, 439) said first material (403, 404, 422, 432, 437, 455) by using xerographic techniques.

181. Method according to one or more of claims 168 to 180, wherein said associating comprises arranging said first material (403, 404, 422, 432, 437, 455) on said transferring means (401, 415, 421, 439), by simultaneously using xerographic techniques and printing techniques with modulated laser beam (435) scanning.

182. Method according to one or more of claims 168 to 181, wherein said associating comprises arranging said first material (403, 404, 422, 432, 437, 455) on said transferring means (401, 415, 421, 439) by using magnetographic techniques.

183. Method according to one or more of claims 168 to 182, wherein said associating comprises arranging said first material (403, 404, 422, 432, 437, 455) on said transferring means (401, 415, 421, 439) by using ionographic techniques.

184. Method according to one or more of claims 168 to 183, wherein said associating comprises arranging on said transferring means (401, 415, 421, 439) said first material (403, 404, 422, 432, 437, 455) by using thermographic techniques (457).

185. Method according to one or more of claims 168 to 184, wherein said associating comprises arranging on said transferring means (401, 415, 421, 439) said first material (403, 404, 422, 432, 437, 455) projected as micro-drops (403, 422).

186. Method according to one or more of claims 168 to 185, wherein said associating comprises arranging on said transferring means (401, 415, 421, 439) said first material (403, 404, 422, 432, 437, 455) in a liquid state, projected as micro-drops (403, 422), said first material (403, 404, 422, 432, 437, 455) subsequently solidifying by cooling after being arranged on said transferring means (401, 415, 421, 439).

187. Method according to one or more of claims 168 to 186, wherein said moving close comprises using the surface of a roller (412) for carrying a layer (413) of said loose material (407, 410, 420, 449) to said transferring means (401, 415, 421, 439).

188. Method according to one or more of claims 168 to 187, wherein said moving close comprises using fluidification means (450) for carrying said loose material (407, 410, 420, 449) to said transferring means (401, 415, 421, 439).

189. Method according to one or more of claims 168 to 188, wherein said transferring occurs with contact between said transferring means (401, 415, 421, 439) and said surface (3).

190. Method according to one or more of claims 168 to 188, wherein said transferring occurs without contact between said transferring means (401, 415, 421, 439) and said surface (3).

191. Method according to one or more of claims 168 to 190, wherein said transferring is caused by vibrating means (418, 453).

192. Method according to one or more of claims 168 to 191, wherein before said transferring it is provided drying said first material (403, 404, 422, 432, 437, 455) and said loose material (407, 410, 420, 449) on said transferring means (401, 415, 421, 439).

193. Method according to one or more of claims 168 to 192, wherein it is provided using said first material (403, 404, 422, 432, 437, 455) in a liquid state.

194. Method according to one or more of claims 168 to 193, wherein it is provided using a material for ceramic as said loose material (407, 410, 420, 449).

195. Device for applying loose material (1, 410, 420, 449) on a surface (3), characterised in that, it comprises:
a transferring means (401, 415, 421, 439), movable from a treatment station (T2) to an applying station (D2) and vice versa;
further first means (405, 434) suitable for associating a first material (403, 404, 422, 432, 437, 455) with selected regions of said transferring means (401, 415, 421, 439), in said treatment station (T2);
computer means (M2, P2) controlling the extension of said selected regions;
further second means (406, 412, 448) suitable for applying said loose material (407, 410, 420, 449) to said transferring means (401, 415, 421, 439).
an applying station (D2) wherein said loose material (407, 410, 420, 449) passes from said transferring means (401, 415, 421, 439) to said surface (3), said passage occurring only in regions corresponding to said selected regions, or only in regions corresponding to the complementary regions of said selected regions.

196. Device according to claim 195, wherein said surface (3) is a surface to be decorated (3), said loose material (407, 410, 420, 449) is a decorating material (407, 410, 420, 449) and said device is a decorating device.

197. Device according to one or more of claims 195 or 196, wherein said surface (3) belongs to a ceramic tile.

198. Device according to one or more of claims 195 to 197, wherein said transferring means (401, 415, 421, 439) is the external surface (401) of a cylinder (402).

199. Device according to one or more of claims 195 to 198, wherein said transferring means (401, 415, 421, 439) is a belt (415, 421, 39) closed in a loop.

200. Device according to one or more of claims 195 to 199, wherein said transferring means (401, 415, 421, 439) has permeable surface.

201. Device according to one or more of claims 195 to 200, wherein said further second means (406, 448) comprises roller means (412), the surface of which causes a layer (413) of said loose material (1, 410, 413, 449) to rotate.

202. Device according to one or more of claims 195 to 201, wherein said further second means (406, 448) comprises diffusing means (450) suitable for forming a gaseous suspension of said loose material (407, 410, 449).

203. Device according to one or more of claims 195 to 202, wherein said further first means (405, 434) comprises a head (405) made of an array of ejecting nozzles.

204. Device according to claim 203, wherein said head (405) is electromechanically working.

205. Device according to claim 203, wherein said head (405) is piezoelectrically working.

206. Device according to one or more of claims 195 to 205, wherein said head (405) cooperates with heating means.

207. Device according to one or more of claims 195 to 206, wherein said further first means (405, 434) comprises devices (434) with xerographic transferring.

208. Device according to one or more of claims 195 to 207, wherein said further first means (405, 434) cooperates with devices for printing with modulated laser beam (435) scanning.

209. Device according to one or more of claims 195 to 208, wherein said further first means (405, 434) comprises devices with ionographic transferring.

210. Device according to one or more of claims 195 to 209, wherein said further first means (405, 434) comprises devices with magnetographic transferring.

211. Device according to one or more of claims 195 to 210, wherein said further first means (405, 434) comprises devices with thermographic transferring.

212. Device according to one or more of claims 195 to 211, wherein said transferring means (401, 415, 421, 439) cooperates with drying means (417).

213. Device according to one or more of claims 195 to 212, wherein said transferring means (401, 415, 421, 439) cooperates with vibrating means (418, 453).

214. Device according to claim 213, wherein said vibrating means (418) operates at ultrasonic frequency.

215. Device according to one or more of claims 195 to 214, wherein said transferring means (401, 415, 421, 439) cooperates with cleaning means (414, 414a, 451, 458).

216. Device according to one or more of claims 200 to 215, wherein said transferring means (439) having permeable surface cooperates with means (444, 445) suitable for creating a vacuum on a face of said transferring means (439).

217. Device according to one or more of claims 200 to 216, wherein said first material (403, 404, 422, 432, 437, 455) is an occluding material for occluding (432, 437) the permeability of said transferring means (439).

218. Device according to claim 217, wherein said occluding material (432, 437) is a powder based on lamellar material.

219. Device according to one or more of claims 200 to 218, wherein said transferring means (439) having permeable surface cooperates with means suitable for filling through openings (454a) of said transferring means (439) with thermo-meltable material (455).

220. Device according to claim. 219, wherein said transferring means (439) cooperates with means (457) suitable for melting or sublimating said thermo-meltable material (455) in selected regions.

221. Device according to claim 220, wherein said transferring means (439) cooperates with means (458) suitable for removing said thermo-meltable material (455) melted or sublimated.

222. Device according to one or more of claims 220 or 221, wherein said means (457) suitable for melting a dot matrix heating means controlled by computer.

223. Device according to one or more of claims 220 to 222, wherein said means (457) suitable for melting is a modulated laser beam controlled by computer.

224. Method for applying material (1, 516), in the form of powders and/or grains, on a surface (3), characterised in that, it comprises the following steps:
associating said material (1, 516) with a plurality of elements (507, 519) arranged in array;
actively and selectively operating with said elements (507, 519) so as to transfer said material (1, 516) to said surface (3).

225. Method for applying material (1, 516) on a surface (3), characterised in that, it comprises the following steps:
associating said material (1, 516) with a transferring means (504, 513);
moving said material (1, 516) on said transferring means (504, 513) towards said surface (3);
selectively and actively operating with a plurality of elements (507, 519) so as to transfer said material (1, 516) from said transferring means (504, 513) to said surface (3).

226. Method according to claim 225, wherein said transferring occurs without contact between said transferring means (504, 513) and said surface (3).

227. Method according to one or more of claims 224 to 226, wherein said operating comprises vibrating said elements (507, 519) with computer control.

228. Method according to one or more of claims 224 to 227, wherein said operating comprises vibrating said elements (507, 519) with piezoelectric means (508).

229. Method according to one or more of claims 224 to 228, wherein said transferring occurs without interference between said elements (507, 519) and said surface (3).

230. Method according to one or more of claims 224 to 229, wherein said associating comprises arranging said material (503, 516) above said elements (507, 519).

231. Method according to one or more of claims 224 to 229, wherein said associating comprises arranging said material (503, 516) below said elements (507, 519).

232. Method according to one or more of claims 224 to 231, wherein said associating comprises preventing said material (1) from flowing through an opening (506) by means of said elements (507) arranged spaced below said opening (506), said elements (507) horizontally extending so as to interfere with the plane corresponding to the static limit sliding angle (133) formed by said material (1) getting out from said opening (506).

233. Method according to claim 232, comprising applying a vibrating motion to said elements (507) and causing said material (1) to flow from said opening (506).

234. Method according to one or more of claims 227 to 233, wherein the vibrating motion of said elements (507, 519) is modulated in intensity.

235. Method according to one or more of claims 227 to 234, wherein the vibrating motion of said elements (507, 519) is modulated in frequency.

236. Method according to one or more of claims 227 to 235, wherein said associating comprises combining said material (503, 516) with a transferring means (504, 513) and carrying said material (503, 516) on said transferring means (504, 513) near said elements (507, 519).

237. Method according to one or more of claims 227 to 236, wherein said material (503, 516) is a decorating material.

238. Method according to one or more of claims 227 to 237, which is applied for obtaining decorations on said surface (3).

239. Method according to one or more of claims 227 to 238, which is applied to production of ceramic tiles (3).

240. Device for applying material (1, 516), in form of powders and/or grains, to a surface (3), characterised in that, it comprises:
a plurality of elements (507, 519) arranged in array, said material being associated (1, 516) with said plurality of elements (507, 519);
computer means (C3, M2) suitable for selectively actuating said elements (507, 519) for transferring said material (1, 516) from said elements (507, 519) to said surface (3).

241. Device for applying material (1, 516) on a surface (3), characterised in that, it comprises:
a transferring means (504, 513) which said material (1, 516) to be applied is associated with;
a plurality of elements (507, 519) suitable for selectively operating on said material (1, 516) so as to transfer said material (1, 516) from said transferring means (504, 513) to said surface (3), said elements (507, 519) being controlled by computer means (C3, M2) point by point.

242. Device according to claim 241, wherein said elements (507, 519) are suitable for transferring said material (1, 516) from said transferring means (504, 513) to said surface (3), without contact between said transferring means (504, 513) and said surface (3).

243. Device according to one or more of claims 240 to 242, wherein said elements (507, 519) are vibrating elements (507, 519).

244. Device according to one or more of claims 240 to 243, wherein said elements (507, 519) are piezoelectric vibrating elements (507, 519).

245. Device according to one or more of claims 240 a 244, wherein said elements (507, 519) are integrated in a board together with the connecting circuits (W) and the converting means for converting a digital signal into an analog signal.

246. Device according to one or more of claims 240 a 244, wherein said elements (507, 519) are not interfering with said surface (3) during working.

247. Device according to one or more of claims 240 to 246, wherein said elements (507) are arranged below said associated material (1).

248. Device according to one or more of claims 240 to 246, wherein said elements (507) are arranged above said associated material (516).

249. Device according to one or more of claims 240 to 247, comprising a container means (502) suitable for containing said material (1), said container means (502) being provided with an opening (506) through which said material (1) flows, said opening (506) being defined by said elements (507) at the bottom thereof.

250. Device according to claim 249, wherein said elements (507) extend, in vertical projection, beyond the cross line (Z) between the plane formed by the static limit sliding angle (B3) of said material (1) and the upper surface (504) of said elements (507).

251. Device according to one or more of claims 240 to 250, wherein the space between said single elements (507, 519) is sealed by an elastic means.

252. Device according to claim 251, wherein said elastic means is arranged only externally with respect to said space and extends on the whole surface of said elements (507).

253. Device according to one or more of claims 241 to 252, wherein said transferring means (504, 513) is shaped as a belt (513).

254. Device according to claim 253, wherein said belt (513) is closed in a loop and movable on rollers (514).

255. Device according to one or more of claims 241 to 254, wherein said transferring means (513) is provided with openings passing through the thickness.

256. Device according to one or more of claims 241 to 254, wherein said transferring means (513) is provided with cavities (520) not passing through the thickness.

257. Device according to one or more of claims 241 to 256, wherein said transferring means (513) is gas permeable.

258. Device according to claim 257, wherein said transferring means (513) cooperates with negative pressure means (−P).

259. Device according to one or more of claims 241 to 258, wherein said transferring means (504, 513) cooperates with feeding means (502, 517, 518) for feeding said material (1, 516).

260. Device according to one or more of claims 240 to 259, which is used for decorating said surface (3).

261. Device according to one or more of claims 241 to 260, which is used for manufacturing ceramic tiles (3).

262. Apparatus for producing ceramic tiles (608), said ceramic tiles (608) being obtained by pressing powders (606) in a die comprising two half-dies (604, 605), said half-dies (604, 605) being moved one away from the other during the powders (606) feeding step and being moved one close to the other during said pressing, said tiles (608) being decorated during the pressing step with decorating materials (615) arranged by decorating means (609) on the surface of at least one of said half-dies (604, 605) characterised in that, said half-dies (604, 605) are vertically aligned and said decorating means (609) is movable from an external position not interfering with said two half-dies (604, 605) to an internal position between said two half-dies (4, 5).

263. Apparatus according to claim 262 wherein said decorating means (609) is constituted by a belt (609) closed in a loop.

264. Apparatus according to one or more of claims 262 or 263 wherein said decorating means (609) in said external position is arranged on the side where pressed tiles (608) exit, with respect to the press.

265. Apparatus according to one or more of claims 263 or 264 wherein on the upper branch of said belt (609) decorating devices are cooperating (614).

266. Apparatus according to one or more of claims 263 or 265 wherein said decorating means (609) cooperates with a pressing means (616) suitable for bringing said decorating means (609) in contact with one of said half-dies (604, 605).

267. Apparatus according to claim 266 wherein said pressing means (616) is constituted by a roller (616).

268. Apparatus according to claim 266 wherein said pressing means (616) is constituted by a doctor blade.

269. Apparatus according to one or more of claims 262 to 268 wherein said decorating materials (615) are in a liquid or pasty state.

270. Apparatus according to one or more of claims 262 to 269 wherein said decorating means (609) is arranged above the feeding devices (607) for feeding powders (606).

271. Apparatus according to one or more of claims 262 to 270 wherein said decorating means (609) is constituted by a roller.

272. Apparatus according to one or more of claims 262 to 271 wherein said decorating means (609) is provided with an engraved surface.

273. Apparatus according to one or more of claims 262 to 272 wherein said decorating means (609) is constituted by a reticular texture having closed and open regions in its thickness.

274. Apparatus according to claim 273 wherein said decorating means cooperates with feeding means suitable for filling said open regions with said decorating materials (615).

275. Apparatus according to claim 274 wherein said feeding means is constituted by a pair of opposite doctor blades on the opposite surfaces of said reticular texture.

276. Method for pressing and simultaneously decorating ceramic tiles (608) in a die comprising two half-dies (604, 605) suitable for being moved one close to the other, comprising the step of pre-arranging decorating materials (615) on at least one of the surfaces of said half-dies (604, 605) by using decorating means (609), characterised in that, it is provided introducing said decorating means (609) into the space between said two half-dies (604, 605) and it is provided extracting said decorating means (609) before said two half-dies (604, 605) are moved one towards the other.

277. Method according to claim 276 wherein said introducing comprises advancing the end of a belt (609).

278. Method according to claim 277 wherein said extracting comprises withdrawing the end of said belt (609).

279. Method according to claim 278 wherein, before said withdrawing, the surface of said belt (609) is brought in contact with the surface of one of said half-dies (604, 605).

280. Method according to one or more of claims 278 or 279 wherein, during said withdrawing, the surface of said belt (609) is kept in rolling contact with the surface of one of said half-dies (604, 605).

281. Method according to one or more of claims 278 to 280 wherein, during said withdrawing, the upper branch of said belt (609) is horizontally stationary, the end (610) of said belt (609) withdraws at a speed V3 and the lower branch of said belt (609) withdraws at a speed V4 twice said speed V3.

282. Method according to claim 277 wherein, during said advancing the upper branch of said belt (609) and the lower branch of said belt (609) advance simultaneously at the same speed (C4).

283. Method according to one or more of claims 277 and 282 wherein during said advancing decorating means (614) is activated, said decorating means (614) being suitable for arranging decorating materials (615) on the surface of said belt (609).

284. Method according to one or more of claims 277 to 283 wherein, during said advancing, during said withdrawing and possibly during stop of said belt (609) decorating devices (614) are operating, said decorating devices (614) being suitable for arranging decorating materials (615) on the surface of said belt (609) which decorating devices (614) and being kept at a constant translation speed with respect to the upper branch of said belt (609) during the whole period of said operating.

285. Method according to one or more of claims 262 to 269 wherein said pre-arranging comprises activating attraction means acting on said decorating materials (615).

286. Method according to any of claims 262 to 285 wherein said pre-arranging comprises activating electrostatic attraction means acting on said decorating materials (615).

287. Method according to one or more of claims 262 to 286 wherein said pre-arranging comprises using adhesive means acting on said decorating materials (615).

288. Method according to one or more of claims 262 to 287 wherein said pre-arranging comprises using electromagnetic attraction means acting on said decorating materials (615).

289. Method according to one or more of claims 262 to 288 wherein said pre-arranging comprises using vacuum attraction means acting on said decorating materials (615).

290. Method according to one or more of claims 262 to 289 wherein said pre-arranging comprises using said decorating materials (615) in form of decalcomania.

291. Apparatus for producing objects, particularly ceramic tiles (608), said object being obtained by pressing powders (704) and being provided with a surface decorated during pressing, comprising:
pressing means (708, 719, 726) arranged above said powders and at least partially rotating about at least a horizontal axis;
decorating means (711, 713) suitable for arranging decorating materials (714) on the surface of said pressing means (708, 719, 726).

292. Apparatus according to claim 291, wherein said pressing means (708, 719, 726) is constituted by a belt (708, 726).

293. Apparatus according to claim 292, wherein said belt (708) is shaped as a closed loop.

294. Apparatus according to one or more of claims 292 and 293, wherein said belt (708, 726) is wound around rollers (709, 710) having horizontal axis.

295. Apparatus according to claim 294, wherein said belt (708) cooperates with a body (707, 724, 727) arranged above said belt (708) and movable in vertical direction (F1).

296. Apparatus according to one or more of claims 293 to 295, wherein said belt (708) cooperates with a body (706) arranged below said belt (708) and movable in vertical direction (F1).

297. Apparatus according to one or more of claims 291 to 296, wherein said powders (704) are conveyed towards said pressing means (708, 719) above a base belt (701).

298. Apparatus according to one or more of claims 292 to 297, wherein said decorating means (711, 713) is suitable for depositing said decorating materials (714) on the upper branch of said belt (708, 726) on the upwards surface thereof.

299. Apparatus according to one or more of claims 292 to 298, wherein said belt (708, 726) cooperates with rolling means suitable for transmitting the pressing force.

300. Apparatus according to one or more of claims 292 to 299, provided with means (722, 727, 728) suitable for cutting portions of said belt (726).

301. Apparatus according to one or more of claims 291 to 300, wherein said pressing means (708, 719, 726) comprises at least a roller (719).

302. Apparatus according to one or more of claims 291 to 301, comprising means (711) suitable for causing selected surfaces of said pressing means (708, 719, 726) to become temporarily adhesive.

303. Apparatus according to claim 302, wherein said decorating means (711, 713) comprises distributing means (713) for distributing powders and/or grits, said powders and/or grits being suitable for adhering to said selected surfaces.

304. Apparatus according to one or more of claims 291 to 303, wherein said pressing means (708, 719, 726) cooperates with drying means (712).

305. Apparatus according to one or more of claims 291 to 304, wherein said pressing means (708, 719, 726) cooperates with heating means.

306. Apparatus according to one or more of claims 291 to 305, wherein said pressing means (708, 719, 726) cooperates with cleaning means (720).

307. Apparatus according to one or more of claims 291 to 307, wherein said pressing means (708, 726) cooperates with frame means (722) arranged below said pressing means (708, 726).

308. Apparatus according to one or more of claims 291 to 307, wherein said pressing means (708, 726) cooperates with frame means (728) arranged above said pressing means (708, 726).

309. Apparatus according to one or more of claims 291 to 308, wherein said pressing means (708, 719, 726) is provided with a surface provided with cavities and/or protrusions.

310. Apparatus according to claim 309, wherein said protrusions define preferred fracture lines corresponding to the edge of a tile (715).

311. Apparatus according to one or more of claims 297 to 310, wherein decorating means is present (718) for arranging decorating materials above said base belt (711).

312. Method for producing objects, in particular ceramic tiles (608), said objects being obtained by pressing powders (704) and being provided with a surface decorated during pressing, comprising the following steps:
arranging decorating materials (714) on the surface of a body (708, 719, 726) rotatingly movable at least in one of its portions about at least one horizontal axis;
moving said surface, together with said decorating materials (714), around said at least one horizontal axis so as to overlap said decorating materials (714) to a layer (705, 723) of powders (704) designed for forming the object (608);
using the surface of said body (708, 719, 726) for pressing said underlying layer (705, 723), together with said decorating materials (714).

313. Method for producing objects, in particular ceramic tiles (608), said object being obtained by pressing powders (704) and being provided with a surface decorated during pressing, comprising the following steps:
arranging decorating materials (714) on the surface of a belt (708, 726);
moving said belt (708, 726), together with said decorating materials (714), so as to overlap said decorating materials (714) from above to a layer (705, 723) of powders (704) designed for forming the object (608);
using said belt (8, 26) for pressing the underlying powders (4), together with said decorating materials (14);

314. Method for producing objects, in particular ceramic tiles (608), said object being obtained by pressing powders (704) and being provided with a surface decorated during pressing, comprising the following steps:
arranging decorating materials (714) on the external surface of a roller (719) rotatable about a horizontal axis;
rotating said roller (719) together with said decorating materials (714) so as to overlap said decorating materials (714) to a layer of powders (714) designed for forming the object (715);
using the external surface of said roller (719) for pressing the underlying powders (704) together with said decorating materials (714).

315. Method according to one or more of claims 312 to 314 wherein said arranging comprises applying decorating materials (714) in a liquid and/or pasty state.

316. Method according to one or more of claims 312 to 315 wherein said arranging comprises applying adhesive materials.

317. Method according to claim 316 wherein decorating materials in form of powders and/or grains are applied to said adhesive materials.

318. Method according to one or more of claims 312 to 317 wherein said arranging comprises applying decorating materials (714) on said upwards surface (708, 719, 726).

319. Method according to one or more of claims 312 to 318 wherein said moving occurs continuously and at constant speed.

320. Method according to one or more of claims 312 to 318 wherein said moving occurs intermittently, i.e. comprises moving periods alternated with stationary periods.

321. Method according to claim 320 wherein said using occurs in said stationary periods.

322. Method according to one or more of claims 312 to 321 wherein, before said using, a portion of said surface (726) is separated corresponding to the surface of the object (608) to be pressed.

323. Method according to one or more of claims 312 to 322 wherein said arranging occurs during said moving.

324. Method according to one or more of claims 320 to 323 wherein said arranging occurs in said moving periods and in said stationary periods.

325. Method according to claim 324 wherein during said arranging, the decorating devices (714) are movable in translation with a constant speed with respect to said surface (708, 719, 726).

326. Method according to one or more of claims 312 to 325 wherein in a subsequent step it is provided to cut the pressed objects in form of tiles (608).

327. Method according to one or more of claims 312 to 326 wherein further pressing said tiles (608) is provided in a subsequent step.

328. Method according to one or more of claims 312 to 327 wherein firing said tiles (608) is provided in a subsequent step for obtaining ceramic tiles.

329. Decorating method characterised in that, it provides:
forming a flow of decorating powders in an advancing direction,
acting on said flow for modifying said direction.

330. Decorating device characterised in that, it comprises:
forming means for forming a powdered flow along a direction,
modifying means for modifying said direction.
